(19) United States
(12) Patent Application Publication
(10) Pub. No.: US 2026/0112810 A1
(43) Pub. Date: Apr. 23, 2026

(54) Compact Stowing of an Antenna on a Space Vehicle using a Multi-Axis Boom

(71) Applicant: MacDonald, Dettwiler and Associates Corporation, Sainte-Anne-de-Bellevue (CA)

(72) Inventors: Anthony BOLDUC, Montreal (CA); Marc-André VERREAULT, Les Cèdres (CA); Marc-André GODIN, Laval (CA); François Alexandre PAQUIN, Sainte-Martine (CA); David HUET, Senlisse (FR); Philippe GLOBENSKY, Montreal (CA)

(21) Appl. No.: 18/920,796

(22) Filed: Oct. 18, 2024

Related U.S. Application Data
(60) Provisional application No. 63/591,943, filed on Oct. 20, 2023.

(51) Int. Cl. H01Q 3/16; H01Q 1/12; H01Q 1/28

(52) U.S. Cl. CPC H01Q 3/16; H01Q 1/1228; H01Q 1/288

(57) ABSTRACT

A system for compact stowing of an antenna using a multi-axis boom, and methods of using the same, are provided. The antenna includes a feed device for providing/receiving a signal, a reflector for reflecting the signal, and a boom for deploying the reflector by transitioning from a first boom configuration to a second boom configuration, the transition moving the reflector from a first to a second reflector position. The boom includes a first boom segment providing a length of the boom, a proximal rotatable joint disposed at a proximal end of the boom and rotatable about a proximal joint rotation axis, a distal rotatable joint connectable to the reflector and rotatable about a distal joint rotation axis, and a first actuator configured to transition the boom from the first boom configuration to the second boom configuration by rotating a rotatable joint about the corresponding rotation axis.

### TECHNICAL FIELD

The following relates generally to antenna systems and reflectors, and more particularly to systems and methods for compact stowing of an antenna of a space vehicle.

### INTRODUCTION

As space vehicle launch capabilities increase and improve, there is growing demand for space vehicles (also known as spacecrafts), and particularly satellites. Part of this market includes space vehicle models that are more compact than traditional space vehicles (i.e., the “smallsat market”). The deployment of these compact space vehicles typically carries a lower cost compared to their larger counterparts. Particularly, launch costs for these vehicles are lower than large space vehicles, as smaller launchers (i.e., launch rockets) or rideshare missions may be used. Therefore, reducing the size of the space vehicles reduces mission cost and provides a cost-effective option for missions with small budgets.

Optimal deployment configurations, (i.e., geometries) of certain necessary space vehicle equipment, such as antenna reflectors, may frustrate these size considerations particularly at launch. While methods exist for stowing reflectors during launch, for example, some existing systems use prismatic or telescoping booms that extend via concentric boom segments, these methods traditionally require custom parts and materials, and complex deployment testing setups. These parts and tests can be expensive.

Furthermore, existing booms fail to accommodate the geometry (size or shape) of the corresponding antenna or space vehicle. For example, while there may be a desire for more compact space vehicles, mission requirements may necessitate a large antenna or space vehicle geometries. Existing booms, such as telescoping booms, may not provide the capability to support such large geometries with required torsional rigidity, adjustability and thermoelastic stability.

Therefore, current systems and methods are limited in providing the optimal deployment geometry for missions or mission actions, such as trimming in azimuth and/or elevation, steering, zooming, or aligning. For example, in orbit, an antenna may need to be re-aligned to achieve optimal transmission. Existing methods do not provide the capability to perform this re-alignment or to accommodate the optimal alignment geometry.

Accordingly, there is a need for an improved system and method for compact stowing on space vehicles that overcomes at least some of the disadvantages of existing systems and methods.

### SUMMARY

Provided herein is a method of stowing and deploying an antenna, the method comprising stowing an antenna reflector on a spacecraft platform with a multi-axis boom, the multi-axis boom foldable at multiple joints, releasing a first set of hold and release mechanism (HRM) securing the antenna reflector to the spacecraft platform, and deploying the antenna reflector to a deployed position by sequentially unfolding the boom at the joints to reflect radiofrequency (RF) waves to or from a feed device.

The method may further comprise releasing a second set of hold and release mechanisms securing the boom to the spacecraft platform.

The deployed position may be a position away from the spacecraft platform.

The antenna reflector may be stowed on a nadir deck of the spacecraft platform, wherein the boom, when folded, positions the antenna reflector parallel or near parallel to the nadir deck.

The boom, when folded, may position the antenna reflector parallel or near parallel to the nadir deck.

The boom may be mounted to the spacecraft platform on a side adjacent to the nadir deck.

The feed device may be mounted to the same side of the spacecraft platform as the boom.

Sequentially unfolding the boom at the joints may include unfolding the boom via at least three joints.

The at least three joints may have respective axes of rotation that are parallel to one another.

The deployed position may position the antenna reflector to at least one of receive and transmit RF waves unobstructed by the spacecraft platform or any components disposed thereon.

The method may further comprise actuating at least one of the joints of the boom to move the antenna reflector closer to the spacecraft platform or further away from the spacecraft platform to change a focal length of the antenna.

Actuating the at least one of the joints of the boom may include rotating the at least one joint to reduce or increase a joint angle between adjacent boom segments connected by the at least one joint to move the antenna reflector closer to or further from the spacecraft platform.

At least one of the multiple joints may trim the antenna in azimuth.

The joint closest to the spacecraft may trim the antenna in azimuth. The joint closest to the reflector may trim the antenna in azimuth.

The boom may include a trimming joint for trimming or steering the antenna by rotating the antenna reflector by the trimming joint.

The trimming joint may trim or steer the antenna in elevation by rotating the trimming joint.

The method may further comprise trimming or steering the antenna in azimuth by at least one of the multiple joints, wherein the axis of rotation of the trimming joint and the axis of rotation of the at least one of the multiple joints are approximately orthogonal. “Approximately orthogonal” may include wherein the axes of rotation are at between 80-90°.

The foldable joint closest to the spacecraft may be used to trim or steer the antenna. The foldable joint closest to the antenna may be used to trim or steer the antenna.

The joint for trimming in azimuth may be rotatably coupled to the trimming joint.

The multiple joints may include a set of joints for unfolding the boom with parallel axes of rotation, and wherein the trimming joint has an axis of rotation that is nonparallel to the parallel axes of rotation of the set of joints for unfolding the boom.

The trimming joint may be rotatably coupled to another one of the joints of the boom that has an axis of rotation that is nonparallel to an axis of rotation of the joint for trimming, and wherein the joint for trimming rotates about the other one of the joints.

The antenna may be a single offset antenna.

In an embodiment, the antenna is a first antenna and the antenna reflector is a first antenna reflector and the method further includes performing, for a second antenna of the spacecraft platform: stowing a second antenna reflector on the spacecraft platform with a second multi-axis boom, the second multi-axis boom foldable at multiple joints; releasing a second set of HRMs securing the second antenna reflector to the spacecraft platform; and deploying the second antenna reflector to a deployed position by sequentially unfolding the second boom at the joints to reflect RF waves to or from a second feed device. The second antenna reflector and the first antenna reflector are stacked on one another when stowed.

The first and second antenna reflectors of the first and second antennas may be stowed on a nadir deck of the spacecraft platform.

The first antenna and the second antenna may be deployed on opposite sides of the spacecraft platform. The first and second antenna may be on the same side of the spacecraft platform. The first and second antenna may be on adjacent sides of the spacecraft platform.

Provided herein is a system for stowing and deploying an antenna on a spacecraft, the system comprising a feed device for transmitting and/or receiving radiofrequency (RF) waves, an antenna reflector for reflecting the RF waves to or from the feed device, a boom attached to the antenna reflector and to the spacecraft, the boom comprising a plurality of joints for folding the boom to stow the antenna reflector and unfolding the boom to deploy the antenna reflector to a deployed position.

The plurality of joints may have parallel axes of rotation for unfolding the boom.

At least one of the multiple joints may trim the antenna in azimuth.

The joint closest to the spacecraft may trim the antenna in azimuth. The joint closest to the reflector may trim the antenna in azimuth.

The boom may include a trimming joint for trimming or steering the antenna by rotating the antenna reflector by the trimming joint.

The trimming joint may trim or steer the antenna in elevation by rotating the trimming joint.

The method may further comprise trimming or steering the antenna in azimuth by at least one of the multiple joints, wherein the axis of rotation of the trimming joint and the axis of rotation of the at least one of the multiple joints are approximately orthogonal. “Approximately orthogonal” may include wherein the axes of rotation are at between 80-90°.

The foldable joint closest to the spacecraft may be used to trim or steer the antenna. The foldable joint closest to the antenna may be used to trim the antenna.

The joint for trimming in azimuth may be rotatably coupled to the trimming joint.

The multiple joints may include a set of joints for unfolding the boom with parallel axes of rotation, wherein the trimming joint has an axis of rotation that is nonparallel to the parallel axes of rotation of the set of joints for unfolding the boom.

The trimming joint may be rotatably coupled to another one of the joints of the boom that has an axis of rotation that is nonparallel to an axis of rotation of the joint for trimming, and wherein the joint for trimming rotates about the other one of the joints.

The boom may include at least two boom segments connected in series and three joints, and wherein one of the three joints is either (I) coupled to a third boom segment that is fixedly attached to the antenna reflector, or (ii) coupled to a fourth joint that is coupled to the antenna reflector and that rotates along an axis of rotation nonparallel to the one of the three joints.

Rotation of the fourth joint may trim the antenna in elevation.

The antenna reflector may be stowed on a nadir deck of the spacecraft platform, and wherein the boom when folded positions the antenna reflector parallel or near parallel to the nadir deck.

The boom, when folded, may position the antenna reflector parallel or near parallel to the nadir deck.

The boom may be mounted to the spacecraft platform on a side adjacent to the nadir deck.

The feed device may be mounted to the same side of the spacecraft platform as the boom.

Sequentially unfolding the boom at the joints may include unfolding the boom via at least three joints.

The at least three joints may have respective axes of rotation that are parallel to one another.

The deployed position may position the antenna reflector to be unobstructed by the spacecraft platform or any components disposed thereon.

The boom may adjust a focal length of the antenna by actuating at least one of the joints to move the antenna reflector closer to the spacecraft platform or further away from the spacecraft platform.

The antenna may be a single offset antenna.

The antenna may be a first antenna, and the system may further comprise a second antenna, the second antenna comprising a second feed device for transmitting and/or receiving a second set of radiofrequency (RF) waves. a second antenna reflector for reflecting the second set of RF waves to or from the second feed device, a second boom attached to the second antenna reflector and to the spacecraft, the second boom comprising a second plurality of joints for folding the second boom to stow the second antenna reflector on top of the antenna reflector of the first antenna and unfolding the boom to deploy the second antenna reflector to a second primary deployed position.

The first and second antennas may deploy on opposite sides of the spacecraft platform. The first and second antenna may be on the same side of the spacecraft platform. The first and second antenna may be on adjacent sides of the spacecraft platform.

Provided herein is a stowable antenna system comprising a base, an antenna comprising a feed device for providing or receiving a signal, and a reflector for reflecting the signal; and a multi-axis boom for deploying the antenna by moving the reflector from a first position to a second position, the boom comprising at least one boom segment providing a length of the boom, a proximal rotatable joint disposed at a proximal end of the boom and rotatable about a proximal joint rotation axis, wherein the proximal end of the boom is relative to a connection to the base, a distal rotatable joint for rotatably connecting the boom to the reflector, wherein the distal rotatable joint is connectable to the reflector and rotatable about a distal joint rotation axis, and a first actuator configured to move the boom by rotating at least one rotatable joint of the boom about the corresponding rotation axis, wherein the boom deploys the antenna by moving the reflector from the first reflector position to the second reflector position by the first actuator.

The at least one boom segment may further comprise n boom segments, wherein n is any integer greater than 1, wherein each of the n boom segments is rotatably connected by a corresponding rotatable joint to adjacent boom segments, wherein each rotatable joint is rotatable about a corresponding rotation axis.

Each rotatable joint may comprise a rotary actuator for rotating the rotatable joint.

Each rotation axis may be parallel to the remaining rotation axes.

The antenna system may further comprise a misaligned rotatable joint rotatable about a misaligned rotation axis, wherein the proximal and distal rotation axes are parallel, and the misaligned rotation axis is nonparallel to the proximal rotation axis and wherein rotating the misaligned rotatable joint transitions the reflector from a first orientation to a second orientation relative to the feed device.

One of the proximal rotatable joint and the distal rotatable joint may comprise the misaligned rotatable joint.

The second antenna position may have a shorter or longer focal length than the first antenna position.

The second antenna position may have an improved alignment with the feed device compared to the first antenna position.

The at least one boom segment may further comprise a distal boom segment connected at a proximal end to the distal rotatable joint and at a distal end to the reflector.

The first actuator may be disposed in the proximal rotatable joint, wherein the boom further comprises a second actuator disposed in the distal rotatable joint and wherein each actuator comprises one or more of a stepper motor and a spring joint for rotating the corresponding rotatable joint.

The antenna may be a Gregorian antenna, and wherein the antenna further comprises a subreflector for reflecting the signal to the reflector.

The subreflector may be fixed.

The subreflector may be a deployable subreflector on a multi-axis boom.

Provided herein is a vehicle comprising a platform, an antenna system comprising a first antenna comprising: a first feed device for providing or receiving a first signal, the first feed disposed on a first side of the platform, and a first reflector for reflecting the first signal, and a first boom for deploying the first antenna in a first antenna second geometry by moving the first reflector from a first reflector first position to a first reflector second position the first boom comprising: at least three first boom segments each providing length to the first boom, at least two first boom intermediate rotatable joints each first boom intermediate rotatable joint rotatably and consecutively connecting the at least three first boom segments, and at least one first boom actuator configured to transition the first boom from a first boom first configuration to a first boom second configuration by rotating at least one rotatable joint of the first boom, wherein the first boom deploys the first antenna in the first antenna second antenna geometry by moving the first reflector from the first reflector first position to the first reflector second position via the rotation by the first boom actuator.

The boom in the first configuration may position the first antenna in a stowed configuration.

The vehicle may be more compact with the first antenna in the stowed configuration compared to the deployed configuration.

The first reflector in the first position may be positioned on a nadir deck of the platform.

The first boom may further comprise at least one misaligned rotatable joint rotatably connecting at least two boom segments of the first boom, the misaligned rotatable joint rotatable about a misaligned rotation axis wherein rotation axes of the first boom proximal, distal and intermediate joints are parallel and the misaligned rotation axis is nonparallel to the first boom proximal rotation axis and wherein rotating the misaligned rotatable joint transitions the first reflector from a first orientation to a second orientation relative to the first feed.

The first antenna may have a shorter focal length in the second antenna geometry than in a first geometry, the first geometry corresponding to the first position.

The first boom in the second configuration may position the first reflector in an improved alignment with the feed device than the first boom in the first configuration.

The antenna system may further comprise: a second antenna comprising: a second feed device for providing or receiving a second signal, the second feed disposed on a second side of the platform, and a second reflector for reflecting the second signal, and a second boom for deploying the second antenna in a second antenna second geometry by moving the first reflector from a second reflector first position to a second reflector second position, the second boom comprising: at least three second boom segments each providing length to the second boom, at least two second boom intermediate rotatable joints each second boom intermediate rotatable joint rotatably and consecutively connecting the at least three second boom segments, and at least one second boom actuator configured to transition the second boom from a second boom first configuration to a second boom second configuration by rotating at least one rotatable joint of the second boom, wherein the second boom deploys the second antenna in a second antenna second antenna geometry by moving the second reflector from the second reflector first position to the second reflector second position via the rotation by the second boom actuator.

The first reflector in the first position and the second reflector in the second reflector first position may be stacked.

The platform may comprise a hold and release mechanism configured to releasably hold one or more of the first boom and the first reflector.

The hold and release mechanism may be configured to releasably hold a plurality of components of the first antenna and release a first component of the plurality of components independently from the remaining held components.

Provided herein is a method of deploying a stowable equipment using a multi-axis boom, the method comprising moving, by the multi-axis boom, the equipment from a stowed position to a deployed position by rotating at least one rotatable joint of the boom to transition the boom from a first boom configuration to a second boom configuration, wherein the boom comprises: at least a first boom segment providing a length of the boom, a proximal rotatable joint disposed at a proximal end of the boom and rotatable about a proximal joint rotation axis, a distal rotatable joint for rotatably connecting the boom to the reflector, wherein the distal rotatable joint may be connectable to the reflector and rotatable about a distal joint rotation axis, and a first actuator configured to transition the boom from the first boom configuration to the second boom configuration by rotating at least one rotatable joint of the boom about the corresponding rotation axis.

The stowable equipment may be on a space vehicle, wherein the boom in the first configuration disposes the payload in a stowed configuration and wherein the space vehicle is more compact with the antenna in the stowed configuration than in the second antenna geometry.

The stowable equipment may be an antenna reflector, wherein the boom in the first configuration disposes the antenna in a first antenna geometry and wherein deploying the antenna in second antenna geometry performs at least one of zooming the antenna by reducing a focal length of the antenna, trimming the antenna, steering the antenna, or aligning the antenna.

The boom may further comprise a second boom segment rotatably connected to the proximal boom segment by a second rotatable joint and a third boom segment rotatably connected to the second boom segment and by a third rotatable joint and the proximal boom segment by the proximal rotatable joint, the method further comprising: rotating, in the first angular direction, the second rotatable joint in the first direction a determined rotation amount, rotating the third rotatable joint in a second direction the determined rotation amount wherein the second direction is rotationally opposite the first direction.

The method may further comprise rotating, by the first actuator, at least one rotatable joint of the first boom to transition the first boom back to the first configuration.

The method may further comprise rotating at least one rotatable joint of a second boom to dispose the second boom and a second stowable equipment out of an interference path of the first boom and first reflector.

Provided herein is a method of deploying antennas on a spacecraft, comprising deploying a first antenna reflector using a first multi-axis boom, deploying a second antenna reflector using a second multi-axis boom, trimming the first antenna reflector by adjusting a position or orientation of the spacecraft, reflecting a first radiofrequency (RF) signal with the trimmed first antenna reflector, trimming the second antenna reflector by rotating a rotatable joint of the second multi-axis boom, and reflecting a second RF signal with the trimmed second antenna reflector.

Provided herein is a stowable equipment spacecraft system including a spacecraft, a stowable equipment, a multi-axis boom for deploying the stowable equipment by moving the stowable equipment from a first position to a second position, the boom comprising at least one boom segment providing a length of the boom, a proximal rotatable joint disposed at a proximal end of the boom and rotatable about a proximal joint rotation axis, wherein the proximal end of the boom is relative to a connection to the spacecraft, a distal rotatable joint for rotatably connecting the boom to the stowable equipment, wherein the distal rotatable joint is connectable to the stowable equipment and rotatable about a distal joint rotation axis; and a first actuator configured to move the boom by rotating at least one rotatable joint of the boom about the corresponding rotation axis, wherein the boom deploys the stowable equipment by moving the stowable equipment from the first position to the second position by the first actuator.

The at least one boom segment may further comprise n boom segments, wherein n is any integer greater than 1, wherein each of the n boom segments is rotatably connected by a corresponding rotatable joint to adjacent boom segments, wherein each rotatable joint is rotatable about a corresponding rotation axis.

Each rotatable joint may comprise a rotary actuator for rotating the rotatable joint.

Each rotation axis may be parallel to the remaining rotation axes.

Provided herein is a method of stowing and deploying a stowable equipment on a spacecraft, the method comprising stowing the stowable equipment on a spacecraft platform with a multi-axis boom, the multi-axis boom foldable at multiple joints, wherein the stowable equipment is connected to the multi-axis boom, releasing a first set of hold and release mechanism (HRM) securing the stowable equipment to the spacecraft platform; and deploying the stowable equipment to a deployed position by sequentially unfolding the boom at the joints.

The method may further comprise releasing a second set of hold and release mechanisms securing the boom to the spacecraft platform.

The deployed position may be a position away from the spacecraft platform.

The stowable equipment may be stowed on a nadir deck of the spacecraft platform.

The boom may be mounted to the spacecraft platform on a side adjacent to the nadir deck.

Sequentially unfolding the boom at the joints may include unfolding the boom via at least three joints.

The at least three joints may have respective axes of rotation that are parallel to one another.

The method may further comprise actuating at least one of the joints of the boom to move the stowable equipment closer to the spacecraft platform or further away from the spacecraft platform.

Actuating the at least one of the joints of the boom may include rotating the at least one joint to reduce or increase a joint angle between adjacent boom segments connected by the at least one joint to move the stowable equipment closer to or further from the spacecraft platform.

Provided herein is a system for stowing and deploying a stowable equipment on a spacecraft, the system comprising a spacecraft, a stowable equipment, and a boom attached to the antenna reflector and to the spacecraft, the boom comprising a plurality of joints for folding the boom to stow the antenna reflector and unfolding the boom to deploy the antenna reflector to a deployed position.

The stowable equipment may be stowed on a nadir deck of the spacecraft platform.

The boom may be mounted to the spacecraft platform on a side adjacent to the nadir deck.

Unfolding the boom at the joints may include unfolding the boom via at least three joints.

Other aspects and features will become apparent to those ordinarily skilled in the art, upon review of the following description of some exemplary embodiments.

### BRIEF DESCRIPTION OF THE DRAWINGS

The drawings included herewith are for illustrating various examples of articles, methods, and apparatuses of the present specification. In the drawings:

FIG. 1A is a block diagram of a system for compact stowing and deployment of an antenna on a space vehicle, according to an embodiment;

FIG. 1B is a block diagram of the boom segment of FIG. 1A, according to an embodiment;

FIG. 1C is a perspective view schematic of the boom segment of FIG. 1A, according to an embodiment;

FIG. 1D is a block diagram of the rotatable joint of FIG. 1A, according to an embodiment;

FIG. 1E is a perspective view schematic of the rotatable joint of FIG. 1A, according to an embodiment;

FIG. 2A is a perspective view schematic of a system for compact stowing of an antenna, with the antenna in a stowed configuration, according to an embodiment;

FIG. 2B is a perspective view schematic of the system of FIG. 2A, with the antenna in a deployed configuration, according to an embodiment;

FIG. 2C is a perspective view schematic diagram of the multi-axis boom of FIG. 2A, in isolation;

FIG. 2D is a perspective view schematic diagram of the multi-axis boom of FIG. 2B, in isolation;

FIG. 3A is a side view schematic of the multi-axis boom of FIG. 1A in a stowed configuration, according to an embodiment;

FIG. 3B is a perspective view schematic of the multi-axis boom of FIG. 1A in a deployed configuration, according to an embodiment;

FIG. 4A is a side view schematic diagram of a system for compact stowing of two antennas in a stowed configuration, according to an embodiment;

FIG. 4B is side view schematic diagram of the system of FIG. 4A, with the antennas in a deployed configuration;

FIG. 5 is a flow diagram of a method of deploying the stowable equipment of FIG. 1A via a multi-axis boom of FIG. 1A, (i.e., a deployment sequence) according to an embodiment;

FIGS. 6A through 6H are side view schematic diagrams of the system of FIG. 3A being deployed according to the deployment method of FIG. 5, according to an embodiment;

FIG. 7A is a side view block diagram of a system for compact stowing of an antenna in an initial or primary deployed configuration, according to an embodiment;

FIG. 7B is a side view block diagram of the system of FIG. 7A in a zoomed-in configuration relative to the deployed configuration of FIG. 7A, according to an embodiment;

FIG. 7C is a side view block diagram of the system of FIG. 7A in a trimmed configuration relative to the deployed configuration of FIG. 7A, according to an embodiment; and

FIG. 8 is a flow diagram of a method of deploying a first antenna and a second antenna, including trimming the antennas, according to an embodiment;

FIG. 9A is a perspective view schematic diagram of a system for compact stowing and deployment of an antenna on a space vehicle including a four axis boom, according to an embodiment;

FIG. 9B is a perspective view schematic diagram of the boom of FIG. 9A in isolation;

FIG. 10A is a perspective view schematic diagram of a system for compact stowing and deployment of an antenna on a space vehicle including a five axis boom, according to an embodiment; and

FIG. 10B is a perspective view schematic diagram of the boom of FIG. 10A in isolation.

### DETAILED DESCRIPTION

Various apparatuses or processes will be described below to provide an example of each claimed embodiment. No embodiment described below limits any claimed embodiment and any claimed embodiment may cover processes or apparatuses that differ from those described below. The claimed embodiments are not limited to apparatuses or processes having all of the features of any one apparatus or process described below or to features common to multiple or all of the apparatuses described below.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article.

The following relates generally to antenna systems and reflectors, and more particularly to systems and methods for stowing boom mounted equipment of a space vehicle. The following also relates generally to stowable booms, and more particularly to systems and methods for stowing equipment of a space vehicle via an articulating multi-axis boom.

The present disclosure provides systems and methods for compact stowing of a payload on a spacecraft using a multi-axis boom. Herein, the “payload” or “stowable equipment” is often described as an antenna and embodiments discuss the particulars of stowing an antenna. However, it is to be understood that other payloads may also be stowed compactly and deployed using a multi-axis boom as described herein, and such embodiments are expressly contemplated herein.

A system for compact stowing of a payload, such as an antenna, is provided. The system includes a multi-axis boom. The multi-axis boom may be referred to as a boom assembly. The multi-axis boom includes a series of boom segments rotatably connected by joints. Each rotatable connection rotates about a corresponding rotation axis. The range of rotation of the joint is limited by the specific mechanism of the joint as well as the interaction of the various segments of the boom. That is the joint may have a range of rotation limited to a certain number of degrees, for example, 300°, and this range of rotation may be limited by the physical capabilities of the joint or may be limited due to the inability of a boom segment to move past another boom segment or payload without abutting.

By rotating the boom segments of the multi-axis boom, any attached equipment may be stowed or deployed in various configurations, or “geometries”. For example, where the attached equipment is an antenna reflector, the reflector may be stowed in a stowed configuration and deployed to a deployed configuration in which a certain antenna geometry is achieved.

The multi-axis boom supports movement of a payload, e.g., an antenna or at least one component of an antenna, from a stowed configuration to deployed configuration (and, in some cases, vice versa). The deployed configuration is any position of the payload enabled or achieved by movement of the multi-axis boom, apart from the stowed configuration. A stowable equipment may have a single deployed configuration or may have several deployed configurations in which the equipment may perform a task or function. The deployed configuration may be any position within the range or movement of the multi-axis boom.

The movement of the joints of the multi-axis boom allows for the broader movement of deploying the payload from the stowed configuration, as well as finer movements for positioning the payload. Where the payload is an antenna reflector, in some embodiments, the multi-axis boom allows for “zooming” of the antenna to change the focal length, and therefore the beam diameter, of an antenna beam, to improve the performance of the antenna. The multi-axis boom may also allow for “trimming” of the antenna, wherein the boresight for the antenna is moved to an optimal position to maximize gain. Trimming may require rotation of the reflector around an X axis and/or a Y axis of the reflector. Therefore, a multi-axis boom capable of trimming will have at least one joint capable of rotating the reflector around the X axis and one joint capable of rotating the reflector around the Y axis. In some embodiments, the multi-axis boom also allows for “steering” the antenna, which enables the antenna to be pointed on a larger scale than trimming. Generally, “trimming” may include moving the antenna on the order of tenths of degrees, e.g. 0.1-0.2°, while “steering” may include moving the antenna on the order of several degrees, e.g., 8-9°. The same joints of the multi-axis boom may be responsible for trimming and steering. Herein, when “trimming” is discussed as a function of a joint, it is to be understood that said trimming may include steering.

In some embodiments, at least one of the joints may be capable of both unfolding the multi-axis boom to deploy the reflector and trimming/steering the boom, with the difference being the magnitude of the movement (i.e., larger movements for folding/unfolding and finer movements for trimming).

The number of rotational axes a multi-axis boom includes may vary for the requirements of a particular embodiment. The number of axes may be based on, for example, mission parameters, space vehicle size, launch envelope (fairing) size, maximum antenna geometry dimensions and/or any combination thereof. In some embodiments, the multi-axis boom may include an additional rotation axis. The additional axis of rotation may support trimming and/or aligning a reflector in radiofrequency (RF) missions, by providing rotation in a direction orthogonal to the other rotation axes.

In stowed configurations, for example during launch, the space vehicle is configured to occupy a smaller (i.e., more compact) volume than in a deployed configuration. This compact configuration beneficially accommodates smaller launch rockets or occupies less rideshare volume than the deployed configuration and launch configurations of existing systems without stowable booms or with telescoping booms. The smaller launch rocket and/or rideshare volumes beneficially reduces the cost of launching space vehicles using a multi-axis boom.

In deployed configurations, for example, where deployed in geostationary orbit (GEO), non-geostationary orbit (NGSO), and in space in general, the rotatable connection of the boom segments may accommodate a broad range of deployment geometries. This range of deployment geometries may accommodate a wider range of missions than geometries of existing booms. For example, the systems of the present disclosure support antenna trimming and/or steering, zooming modification, and realignment, both terrestrially and in space. Supporting these operations supports missions where these operations are beneficial. This can beneficially reduce maintenance costs and increase the lifespan and usage of each space vehicle. In addition to increasing the value of each space vehicle, this opens up space vehicle utilization to a broader market, and reduces the waste generated both terrestrially and in space.

The rotating joints of the multi-axis boom enable geometries with dimensions beyond those of current boom systems (e.g., telescoping joint booms). Therefore, the multi-axis boom of the present disclosure accommodates a wider range of missions than existing systems. In particular, missions with at least one mission stage requiring a long focal length and/or large reflector offset and at least one mission stage with tight space vehicle volume requirements, such as launch and retrieval, are made possible with the multi-axis boom of the present disclosure.

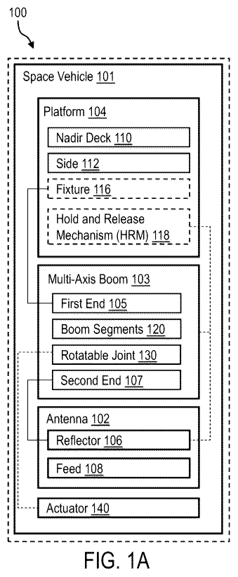

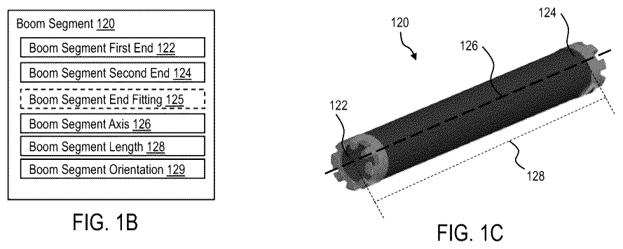

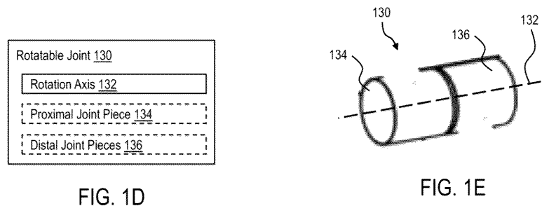

Referring now to FIG. 1A, shown therein is a system 100 for compact stowing and deployment of at least one antenna 102 on a space vehicle 101, according to an embodiment.

In other embodiments, the system may be on a platform or base other than a space vehicle. In other embodiments, the antenna may be any stowable equipment or payload to be stowed and deployed from a platform/base.

The system 100 includes a space vehicle 101 and an antenna 102 disposed on the space vehicle 101.

The space vehicle 101 is a vehicle configured to be deployed in space for a space-based mission. The space vehicle 101 may be a spacecraft. The spacecraft may be a satellite.

The antenna 102 is configured to transmit and/or receive radiofrequency (RF) signals or waves. The antenna 102 is configured to be stowed and deployed in various deployed configurations relative to the space vehicle 101, as further described below.

The antenna 102 is configured, through operation of a multi-axis boom (described below), to fit within a launch envelope (dashed line in FIG. 1A) of the space vehicle 101 when stowed. The launch envelope is a three-dimensional space available for the space vehicle 101 to occupy during launch (e.g., where space vehicle 101 is launched on another spacecraft).

The space vehicle 101 includes a platform 104. The platform forms the foundational structure (or “base”) of the space vehicle 101. Various equipment and subsystems of the space vehicle 101 are connected to and contained within the platform 104. For example, elements of the antenna 102 and the multi-axis boom 103 may be connected to the platform 104.

The platform 104 includes any number of sides 112, which may also be referred to as panels 112. The sides 112 form an outer surface of the platform 104. Each side 112 may be an outer surface of a corresponding wall of the platform 104 or may include the outer surface of equipment of the platform. For example, where a component is attached to a wall of the platform 104, the outer surface of the component and/or outer surface of the wall extending beyond the component may be referred to as a side 112.

In other embodiments, the platform 104 may have different geometries or shapes. In a particular embodiment, the platform 104 is trapezoidal (such as illustrated herein). These geometries are formed by the sides 112 being configured at various relative orientations. In some embodiments, such as where the platform 104 is spherical, the sides 112 and nadir deck 110 may partially or entirely overlap. In these embodiments, there may not exist a delineation, structural or otherwise, between each side 112, the nadir deck 110 (described below), and/or the entire outside surface of the platform 104.

The platform 104 includes at least one nadir deck 110. The nadir deck 110, also known as an earth deck 110, is a reference surface of the platform 104 used to describe the orientation of the platform 104. The nadir deck 110 may thus correspond to a side 112 of the platform 104.

The platform 104 may be configured such that, for typical missions, the nadir deck 110 faces the earth (not shown). It will be appreciated that in some embodiments and/or for some missions, the platform 104 may be configured such that the nadir deck 110 faces other objects, such as other celestial bodies and/or signal receiving systems. In some embodiments, the platform 104 may be oriented such that an edge of the platform 104, sometimes referred to as an “earth edge”, faces the earth. In such embodiments, the platform 104 may have multiple nadir decks 110 that at least partially face the earth.

The platform 104 includes fixtures 116. A fixture 116 is a structure on platform 104 to which a component of antenna 102 may be fixed. Fixtures 116 may include brackets or other mechanical components for attaching or otherwise mechanically coupling antenna components to the platform 104.

Referring again to antenna 102, the antenna 102 includes an antenna reflector 106, a feed 108 (or feed device 108), and a multi-axis boom 103 attached to the reflector 106 for deploying the antenna reflector 106.

In the example of FIG. 1A, the stowable equipment is antenna reflector 106, however, in other embodiments, other stowable equipment may be stowed and deployed by system 100.

The reflector 106 may be any suitable antenna reflector.

The boom 103 is configured to facilitate storage of the boom 103 and the attached antenna reflector 106 within the launch envelope of the space vehicle when the boom 103 is in a stowed configuration.

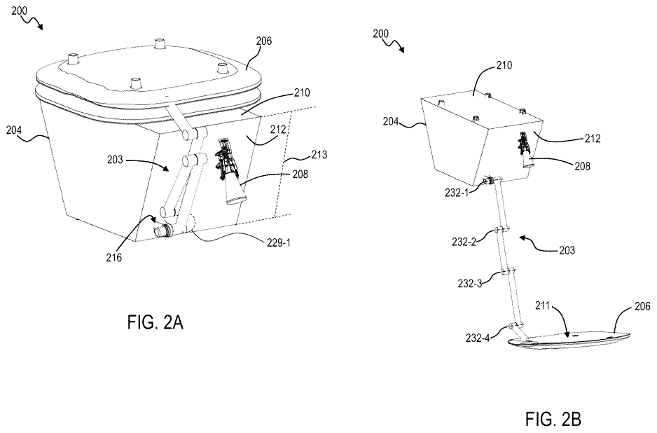

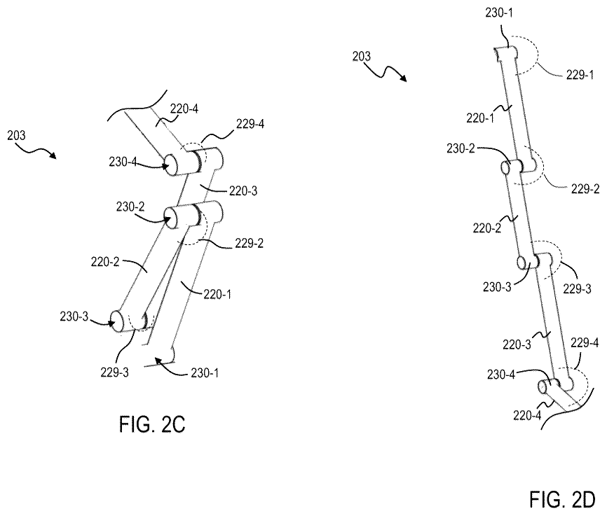

The feed 108 may be a feed horn (e.g., feed horn 208 of FIG. 2). The feed 108 is mechanically coupled to the platform 104 of space vehicle 101. The feed 108 may be fixed in location.

The feed 108 transmits and/or receives a signal. The feed 108 may be communicatively connected to signal generating or processing components of the antenna 102 housed in or on the platform 104 for feeding the signal to and from such components.

Generally, the position of the reflector 106 relative to the feed 108 may be manipulated by the boom 103 to achieve one or more antenna geometries, such as the antenna geometry shown in FIG. 2B.

In some embodiments, the antenna 102 may be a Gregorian antenna. In other embodiments, the antenna 102 may be any shape of antenna. In an embodiment, the antenna 102 may include a fixed feed 108 and a stowable reflector 106. In an embodiment, the antenna 102 may include a fixed feed 108, a fixed subreflector, and a stowable reflector 106. In an embodiment, the antenna 102 may include a fixed feed 108, a deployable subreflector on a first multi-axis boom, and a deployable reflector on a second multi-axis boom. Antennas described and shown herein are example antenna configurations that are possible within the system 101 and the within the present disclosure more generally. Any suitable antenna configuration may be used and such configurations are contemplated by the present disclosure.

Each multi-axis boom 103 is dynamic. That is, the boom 103 is configured to transition between various configurations. In particular, each multi-axis boom 103 is configured to transition from a stowed configuration (e.g., FIG. 2A) to a deployed configuration (e.g., FIG. 2B). The deployed configuration may include an initial or primary deployed configuration and one or more secondary or additional deployed configurations. The one or more secondary deployment configurations may be used to achieve different antenna geometries from that provided by the primary deployment configuration.

The multi-axis boom 103 has a first (proximal) end 105 for connecting to the platform 104 and a second (distal) end 107 for connecting to the reflector 106. The terms proximal and distal refer to positions relative to the platform 104 of the space vehicle 101 when deployed. That is, although various aspects of the multi-axis boom may be closer or farther from the platform and/or the reflector in different positions, the term “proximal” refers to an end of a component which is “connected” in series closer to the platform than to the payload (e.g., reflector) compared to the term “distal” which refers to an end of a component which is “connected” in series closer to a payload (e.g., reflector) than to the platform.

In some embodiments, the connections of the proximal end 105 and the distal end 107 to the platform 104 and the reflector 106, respectively, are fixed. In other embodiments, the connections are rotatable, for example via a rotatable joint 130, further described below. In some embodiments, the connections are detachable. The connection at the proximal end 105 may differ from the connection at the distal end 107. It will be appreciated that where the connection is detachable, the multi-axis boom 103 may detach from antenna reflector 106 and be re-configured independently of the antenna reflector 106. For example, the multi-axis boom 103 may detach from the antenna reflector 106 to be stowed independently of the antenna reflector 106. The multi-axis boom 103 may further detach from the antenna reflector 106 to attach and position a second stowable equipment. It will be appreciated that while the proximal end 105 and the distal end 107 are mutually exclusive ends of the multi-axis boom 103, in some configurations of the multi-axis boom 103, the proximal end 105 and distal end 107 may be substantially collocated. For example, the proximal end 105 and distal end 107 may be substantially collocated in the stowed configuration.

Configuring the multi-axis boom 103 in the stowed configuration stows the connected reflector 106. Stowing the reflector 106 enables various mission stages with optimal overall size and shape parameters, for example launch and recovery stages, by placing the reflector 106 into a stowed configuration instead of a deployed configuration.

The multi-axis boom 103 reduces or minimizes the volume (e.g., size and shape) of the space vehicle when in the stowed configuration, transitions the reflector 106 from a stowed position to a primary or initial deployed position, and allows for optimizing the position of the reflector 106 from the primary deployed position (i.e., by transitioning the reflector 106 from the primary deployed position to one or more secondary deployed positions). Each deployed position of the reflector 106 may be referred to as a deployed geometry or antenna geometry.

The stowed configuration may also be for achieving dimensions of the space vehicle 101 based on prescribed external parameters. For example, the stowed configuration may fit the space vehicle 101 inside a fairing of a launch vehicle.

The stowed configuration of the multi-axis boom 103 may be easily adapted to accommodate a range of launch vehicles and parameters. This enables low cost space vehicle launch options such as those employing small rockets and/or ride shares while enabling missions and tasks requiring large reflectors 106.

The deployed configurations may be predetermined (e.g., prior to launch) or determined remotely. Configuration parameters of the multi-axis boom 103, such as boom segment orientations 129, further described below, may be predetermined to achieve deployed configurations for prescribed missions.

For example, the configuration parameters of a deployed configuration may be determined prior to launching the space vehicle 101. Once launched, the multi-axis boom 103 may be configured in a deployed configuration according to the predetermined configuration parameters to deploy the reflector 106.

This dynamic nature of the multi-axis boom 103 enables testing, for example on earth, for predetermined missions. These remotes tests may be easier or more reliable than testing on location such as in space. Once on location, the dynamic nature of the multi-axis boom 103 enables testing remotely via modeling, including digital and physical modeling. This is particularly of benefit where the mission or operation is not predetermined or where mission timings, such as launch windows, interfere with direct testing.

The dynamic nature of the multi-axis boom further enables dynamic benefits. For example, transitioning the multi-axis boom from a first deployed configuration to a second deployed configuration thereby changing the position of a stowable equipment, accommodates transitioning a space vehicle from performing a first mission, task or operation to a second. This transition may also be for improving the performance of a stowable equipment, changing the mission, task, or operation of a particular stowable equipment, swapping a stowable equipment, or maintaining, repairing, realigning, a stowable equipment, and the like.

For example, where the stowable equipment is a component of an antenna, such as antenna 101, the antenna may be transitioned from a first deployed configuration (i.e. first antenna geometry) to a second deployed configuration (i.e. second antenna geometry). This transition may be to focus, zoom, trim, steer, align, realign, etc. the antenna 101 for various missions or operations.

The multi-axis boom 103 includes multiple boom segments 120. The boom segments 120 are referred to herein collectively as boom segments 120 and individually as boom segment 120.

Each boom segment 120 is rotatably connected in series, by rotatable joints, to form the structure of the multi-axis boom 103. Each boom segment 120 adds to the available length or reach of the multi-axis boom 103.

A specific boom segment 120 is referred to herein as boom segment 120- #where lower numbers #indicate a boom segment that is connected more proximal to the platform 104 than a higher #numbered boom segment 120. For example, proximal boom segment 120-1 refers to a boom segment 120 connected to the platform 104 and boom segment 120-2 refers to a second boom segment 120 connected to proximal boom segment 120-1 and so on. The most distal boom segment may be referred to either by the corresponding boom number #(i.e. in a system with 4 boom segments 120 as distal boom segment 120-4) or as distal boom segment 120-n. Features corresponding to a specific boom segment 120- #are similarly indicated. For example, the boom segment proximal end 122, further described below, corresponding to boom segment 120-2 is referred to herein as boom segment proximal end 122-2.

Referring now to FIGS. 1B and 1C, shown therein are a block diagram and perspective view schematics of a boom segment 120, according to an embodiment. The boom segment 120 includes a first end 122 and a second end 124. The ends 122 and 124 when disposed in a multi-axis boom 103 of FIG. 1A are referred to herein as the boom segment proximal end 122 and the boom segment distal end 124, relative to the proximal end 105 and distal end 107 of the multi-axis boom 103 of FIG. 1A.

An axis along a straight line between the boom segment proximal end 122 and the boom segment distal end 124 is referred to herein as the boom segment axis 126. The distance between the boom segment proximal end 122 and the boom segment distal end 124 along the boom segment axis 126 is referred to herein as the boom segment length 128. It will be appreciated that the boom segment axis 126 and the boom segment length 128, as referred to herein, may or may not be coincident, in full or in part, with the physical boom segment 120. For example, when a boom segment 120 bends or curves, a path along the boom segment 120 will deviate from the boom segment axis 126 and a length of the path along boom segment 120 will be longer than the boom segment length 128.

Referring again to FIG. 1A and also still to FIG. 1B, an orientation of each boom segment 120 is referred to herein as the boom segment orientation 129. A boom segment orientation 129, unless otherwise described, should be understood to be the orientation of the corresponding boom segment axis 126 in the direction of the distal end 107, relative to the component connected to the boom segment proximal end 122. For example, the boom segment orientation 129-1 of a proximal boom segment 120-1 oriented with a boom segment axis 126-1 normal to a side 112 to which it is connected is 90 degrees. In a further example, a second boom segment orientation 129-2 of a second boom segment 120-2 oriented such that the boom segment axis 126-2 is normal and opposite to a boom segment axis 126-1 is 180 degrees. Any rotation of a boom segment 120, unless otherwise described, is to be understood as counterclockwise and relative to the orientation of the boom segment axis 126 prior to the rotation.

The configuration of each multi-axis boom 103 in any geometry is a function of the boom segment length 128 and the boom segment orientation 129 of each included boom segment 120. It will be appreciated that the volume of the space vehicle 101 as well as the disposition (position and orientation) of the connected stowable equipment is a function of this configuration. Each boom segment is designed and manufactured to have a particular boom segment length, whereby disposing each boom segment 120 in a particular boom segment orientation 129 enables achievement of desired space vehicle volumes and configurations (i.e., stowed configurations and deployed configurations/antenna geometries). It will be appreciated that in deployed configurations, each boom segment axis 126 may not be aligned (i.e., parallel) with boom segment axes 126 of the remaining boom segments 120. Configuring the boom segments 120 with boom segment axes 126 that are mis-aligned may beneficially accommodate deployed geometries beyond that of existing systems such as telescoping systems.

Varying the boom segment orientation 129 accommodates a dynamic range of deployed geometries and resulting stowable equipment positions and orientations. The dynamic range accommodates various and multiple missions, tasks and operations including stowable equipment maintenance and repair operations. The dynamic range may also accommodate space vehicle interactions with support options, by enabling a space vehicle to be adapted to the parameters of other vehicles, such as launch vehicles.

Each boom segment 120 may be of various configurations. For example, each boom segment 120 may be in the form of a rod, tube, bar, box beam, I-beam, etc. The configuration of each boom segment 120 may be based on the dimensions of the platform 104 or the intended missions, tasks, and/or geographies of the space vehicle 101. In an example, the platform includes a side 112 along which a portion of the multi-axis boom 103 is intend stowed. In embodiments where the side 112 is flat, each boom segment 120 that forms this portion may be straight. In embodiments where the side 112 is curved, the corresponding boom segments 130 may be similarly curved to match the profile of the side 112.

In a further example each boom segment length 128 may be such that each boom segment 120, when stowed, substantially stays within the profile the bounds of the platform 104 volume. Each boom segment length 128 may differ from the remaining boom segment lengths 128. It will be appreciated that in some embodiments, particular boom segments 120 may have a boom segment length 128 to extend beyond the bounds of the platform 104 volume. For example, a penultimate boom segment 120-(n-1) may extend beyond the nadir deck 110 to enable a stowable equipment to lay flat on the nadir deck 110. It will be appreciated that each boom segment 120 may be configured and composed differently from each and every other boom segment 120.

The multi-axis boom 103 further includes rotatable joints 130. The rotatable joints 130 are referred to collectively as rotatable joint 130 and rotatable joints 130. Specific rotatable joints 130- #and the corresponding features are indicated similarly to specific boom segments 120- #.

Referring to FIGS. 1D and 1E shown therein is a block diagram and perspective view schematic of a rotatable joint 130 according to an embodiment. Referring also to FIG. 1A the rotation of each rotatable joint 130 is about at least one rotation axis 132. In some embodiments, each rotatable joint 130 rotates about a single rotation axis 132. In some embodiments, the rotatable joint 130 is configured such that a rotation axis 132 is normal to the boom segment axes 126 of FIGS. 1B and 1C, of each boom segment 120 connected to the rotatable joint. Rotatable joints 130 with such normally oriented rotation axes 132 accommodate re-orienting the connected boom segments 120. In some embodiments, the rotatable joint 130 is configured such that a rotation axis 132 is in line with a boom segment axis of at least one of the boom segments 120 connected to the rotatable joint. Rotatable joints 130 with such rotation axes 132 oriented in line with boom segment axes accommodate rotating the connected corresponding boom segment 120 about its axis.

The rotation axis 132 of each rotatable joint 130 may be aligned, such as parallel, with the rotation axis 132 of any or all other rotation axes 132. This alignment may be among the rotation axes 132 of each multi-axis boom 103 and/or across multiple multi-axis booms 102 of the space vehicle 101. This alignment simplifies and reduces risk in making deployment paths. In some embodiments, the axes are misaligned to add additional axes based on mission requirements such as avoiding space vehicle 101 equipment, enabling trimming, steering, zooming, or aligning, etc.

Referring again to FIGS. 1B and 1C, each boom segment 120 is rotatably connected to an adjacent boom segment 120 via a rotatable joint 130. The proximal boom segment end 122-1 is further rotatably connected, via rotatable joint 130-1 to the platform 104. Specifically, each rotatable joint 130 rotatably connects each boom segment proximal end 124 to the platform 104 or the proximally preceding boom segment 130. Each rotatable joint 130 other than the most proximal rotatable joint 130-1 connects each corresponding boom segment distal end 126 to the proximal end 124 of the distally following boom segment 130. For example, the platform 104 is rotatably connected to the proximal boom segment proximal end 124-1 via the proximal rotatable joint 130-1 and the proximal boom segment distal end 126-1 is connected to the second boom segment proximal end 124-2 by the second rotatable joint 130-2.

The most distal boom segment 120-n is connected at the distal end 124-n to the corresponding reflector 106. It will be appreciated that this connection may not be via a rotatable joint 130 (i.e. a fixed connection, detachable connection, or other movable joint). It will further be appreciated that in some configurations, the corresponding reflector 106 may be disconnected (i.e. detached). For example, the reflector 106 may be detached to stow the reflector 106 separately from the multi-axis boom 103 or to exchange a stowable equipment.

The configuration of each rotatable joint 130 may be the same or differ within or across embodiments. For example, rotatable joints 130 for a particular space vehicle 101 may be selected based on the mass and size of the stowable equipment and boom segments 120 and the geometries the rotatable joint 130 is intended to accommodate. In some embodiments, rotatable joints 130 within a particular multi-axis boom 103 may be selected based on disposition of the rotatable joint within the multi-axis boom 103. For example, rotatable joints 130 with higher tolerances may be selected for rotatable joints 130 disposed more proximally relative to other rotatable joints 130 due the mass of the additional number of boom segments and longer potential moment arm that the more proximal rotatable joints 130 are intended to accommodate.

It will be appreciated that the quantity of rotatable joints 130 and boom segments 120 may differ in various space vehicle 101 embodiments. These differences may be based on mission, task, and/or operations parameters. For example, embodiments of the space vehicle 101 intended for missions benefiting from less mass may have less rotatable joints 130 and boom segments 120. In a further embodiment, space vehicles intended for missions benefiting from trimming may have at least a fifth rotatable joints 130-5 to for rotating the reflector on an axis of rotation perpendicular to at least one of the other four joints for, such as in elevation, over space vehicles with four rotatable joints 130. That is, at least one of the other four rotatable joints may be configured for trimming the reflector along an axis with the fifth joint configured to trimming the reflector on an orthogonal axis. As described above, trimming may encompass steering.

In other embodiments, the fifth joint may be a ball joint or similar multi-axis joint, which can rotate the reflector in multiple directions.

In some embodiments, each rotatable joint 130 includes a proximal joint piece 134 and a distal joint piece 136 rotatably connected. The proximal joint piece 134-1 (i.e. the first proximal joint piece 134-1) is fixedly connected to the platform 104 and each remaining proximal joint piece 134 is fixedly connected to each remaining boom segment distal end 124. It will be appreciated that it is not necessary for a proximal joint piece 134 to be fixed to the distal boom segment distal end 124-n. Each distal joint piece 136 is fixedly connected to each boom segment proximal end 122. Each proximal joint piece 134 is rotatably connected to the distal joint piece 136 connected to the next boom segment 130 to form the rotatable connection. For example, the proximal joint piece 134-1 is connected to the distal joint piece 136-2.

Each multi-axis boom 103 further includes any number of drive mechanisms 140. The drive mechanisms 140 actuate each boom segment orientation 129 from a first orientation to a second orientation. Each drive mechanism 140 may be dedicated to act on or be disposed in or on a specific rotatable joint 130, or boom segment 120.

In an example, each drive mechanism 140 is a rotary actuator. In this example, each drive mechanism 140 is disposed in and acts on a dedicated rotatable joint 130. That is, each rotatable joint 130 has a respective rotary actuator 140 which actuates the joint 130.

The drive mechanism 140 may be a stepper motor or spring hinge. Each drive mechanism 140 controls the boom segment orientation 129 of a boom segment 120 connected to a dedicated rotatable joint 130 by rotating the dedicated rotatable joint 130.

A drive mechanism 140 may be primarily disposed in either the proximal joint piece 134 or the distal joint piece 136. The drive mechanism 140 may include a post that extends from the joint piece in which it is disposed and interfaces, such as via a gear assembly, with the corresponding other joint piece. The drive mechanism 140 may rotate the post which causes the proximal joint piece 134 to rotate relative to the distal joint piece 136 (i.e. the joint to rotate).

The system 100 also includes one or more hold and release mechanisms (HRMs) 118.

The HRMs 118 are referred to herein individually as HRM 118 and collectively as HRMs 118.

Each HRM 118 is configured to releasably hold or secure a component to the space vehicle 101. The HRM 118 may secure the component in a stowed configuration (e.g., for launch, prior to use, etc.). The HRMs 118 include one or more HRMs for securing the reflector 106. The HRMs 118 include one or more HRMs for securing the boom 103. One HRM 118 may releasably hold multiple components, and a component may be releasably held by multiple HRMs 118.

Releasing an HRM, also referred to as firing an HRM 118, releases the hold of the HRM 118 on the held component(s). With the hold released, the component may transition to another configuration without substantial interference from the HRM 118.

Referring now to FIGS. 2A and 2B, shown therein are perspective view schematics of a system 200 for compact stowing and deployment of an antenna on a space vehicle, according to an embodiment.

FIG. 2A shows the antenna in a stowed configuration and FIG. 2B shows the antenna in a deployed configuration. The system 200 is an embodiment of the system 100 of FIG. 1A. Counterpart components in system 200 are given similar reference numbers to those in FIG. 1A, incremented by 100. Counterpart components in system 200 are understood to be similarly configured and perform the same or similar function to those in FIG. 1A, unless otherwise described.

Simultaneous reference will also be made to FIGS. 2C and 2D, which show the boom 203 of FIGS. 2A-2B in isolation in stowed (2C) and deployed (2D) configurations, respectively.

The system 200 includes a platform 204 of the space vehicle. The antenna is disposed on the platform 204 and includes feed device 208, antenna reflector 206, and multi-axis boom 203.

The multi-axis boom 203 includes four boom segments 220-1, 220-2, 220-3, 220-4 and four rotatable joints 230-1, 230-2, 230-3, 230-4.

Rotatable joint 230-1 rotatably connects the boom 203 at a proximal end 205 to a side 212 of the platform 204 via platform connector 216.

Rotatable joint 230-2 rotatably connects first boom segment 220-1 to second boom segment 220-2.

Rotatable joint 230-3 rotatably connects second boom segment 220-2 to third boom segment 220-3.

Rotatable joint 230-4 rotatably connects third boom segment 220-3 to fourth boom segment 220-4.

Fourth boom segment 220-4 is fixedly connected to reflector 206 via reflector connector (not shown).

The boom segments 220 are sized and shaped to accommodate a compact volume of the space vehicle, in a stowed configuration.

Accordingly, the boom segments 220 are sized and shaped such that in the stowed configuration, the stowable equipment 206 is stowed on the nadir deck.

For example, in the stowed configuration a reflection surface 211 (not shown in FIG. 2A) of the reflector 206 is disposed parallel to, centered on, and at a minimal offset from the nadir deck 210.

The boom segments 220 are further sized to avoid, in a stowed configuration, boom segments 220-1, 220-2, and 220-3 extending substantially beyond the nadir deck 210 or a side 212, for the equipment to fit within the launch envelope.

Satisfying the proceeding, the boom segments 220 are sized to maximize the available range of positions and orientations of the stowable equipment 206 via deployed configurations of the multi-axis boom 203.

Accordingly, the boom segment lengths 228-1, 228-2, and 228-3 are size based on a height 213 of side 212.

The boom segments 220 may further be configured to accommodate fixture 216 being disposed on a strong point of the platform 204 such as an edge. The boom segments 220 may further be configured to avoid (i.e. clear) deployment interference.

The avoided interference may be with features disposed based on configurations of the boom segments 220. For example, the boom segments 220 may be configured to dispose a boom HRM out of the deployment path.

In some embodiments, configurations of the boom segments 220 may be configured based on mission parameters in addition to or instead of the above considerations. For example, certain missions may require a certain size and/or shape of space vehicle at launch that necessitates disposing the stowed equipment 206 off center from the nadir deck 210. These mission parameters may be for specific stages, such as at deployment, during specific operations or tasks, at launch or at retrieval.

In an example stowed configuration, as shown in FIG. 2A, the rotatable joint 230-1 is configured at a rotation to dispose boom segment 220-1 at a boom segment orientation 229-1 of zero degrees (i.e. boom segment 220-1 is substantially parallel to side 212). The rotatable joints 230-2 and 230-3 are configured at rotations to dispose boom segments 220-2 and 220-3 at boom segment orientations 229-2 and 229-3 of substantially 180 degrees (i.e. boom segments 220-2 and 220-3 are in line with boom segment 220-1 and consecutively alternate direction). In this configuration, the boom segments 220-1, 220-2, and 220-3 are substantially disposed against the side 212. The rotatable joint 230-4 is configured at a rotation to dispose boom segment 220-4 at boom segment orientation 229-4 is such that the reflection surface 211 is parallel to the nadir deck 210.

It will be appreciated that the boom segment orientations 229-2 and 229-3 may be offset from 180 degrees (potentially at equal and opposite rotations) to avoid interference of each boom segment 220-1, 220-2, and 220-3 with any or all of rotatable joints 220-2 and 220-3 and the remaining boom segments 220. For example, the offset may be 8 degrees with a boom segment orientation 229-2 of 172 degrees and a boom segment orientation 229-3 of −172 degrees (or 188 degrees).

In a deployed configuration the rotatable joints 230 are configured to achieve boom segment orientations 229-1 through 229-4 and the corresponding multi-axis boom 203 configuration that accommodates mission parameters. For example, the rotatable joints 230 may be configured to achieve a desired antenna geometry by disposing (positioning and orienting) the reflector 206 in a predetermined disposition relative to a feed horn 208. Configuring the rotatable joints 230 may include any rotation about rotation axes 232-1 through 232-4 that does not result in interference between the platform, multi-axis boom 203, and the stowable equipment 206.

In an example deployed configuration, as shown in FIG. 2B, the rotatable joint 230-1 is configured at a rotation to dispose boom segment 220-1 at a boom segment orientation 229-1 of 135 degrees. The rotatable joints 230-2 and 230-3 are configured at rotations to dispose boom segments 220-2 and 220-3 at boom segment orientations 229-2 and 229-3 of zero degrees. In this configuration, the boom segments 220-1, 220-2, and 220-3 are parallel and on the same plane.

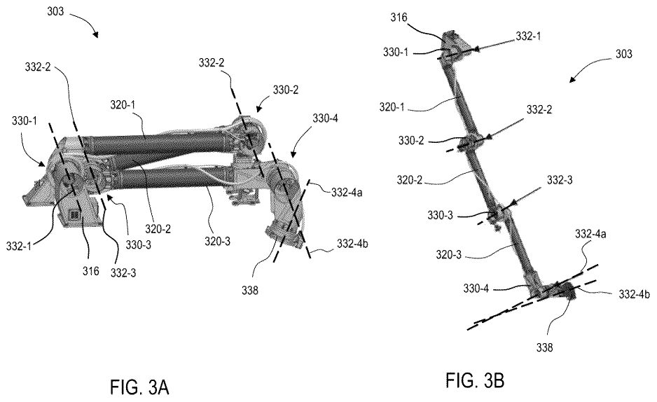

Referring to FIGS. 3A and 3B, shown therein are schematics of a multi-axis boom 303 from a side view in a stowed configuration and from a perspective view in a deployed configuration, respectively, according to an embodiment. The multi-axis boom 303 is an embodiment of the multi-axis boom 103 of FIG. 1A. The multi-axis boom 303 is understood to be similarly configured to the multi-axis boom 103 of FIG. 1A and its corresponding components unless otherwise described.

The multi-axis boom 303 includes three boom segments 320 and four rotatable joints 330. Rotatable joint 330-1 rotatably connects the multi-axis boom 303 to a fixture 316. The rotatable joint 330-1 is rotatable about rotation axis 332-1. Rotatable joint 330-2 rotatably connects boom segment 320-1 to boom segment 320-2. The rotatable joint 330-2 is rotatable about rotation axis 332-2. Rotatable joint 330-3 rotatably connects boom segment 320-2 to boom segment 320-3. The rotatable joint 330-3 is rotatable about rotation axis 332-3. Rotatable joint 330-4 is connected to boom segment 320-3. Rotatable joint 330-4 is connectable to a stowable equipment such as the reflector 106 of FIG. 1A via an interface 338. The rotatable joint 330-4 is rotatable about rotation axis 332-4a and rotation axis 332-4b.

Rotation axis 332-4a mis-orientated to rotation axis 332-4b in at least one dimension. The mis-orientation is such that the rotation axis 332-4a is oblique or normal/perpendicular (i.e. not parallel) to rotation axis 332-4b. Where the multi-axis boom 303 is connected to a reflector stowable equipment, this misorientation accommodates trimming in elevation and/or azimuth independently.

It is expressly contemplated that any or all of the rotatable joints 330 may comprise multiple rotation axes 332- #. These rotation axes may be substantially collocated (as shown) or separated by an offset such as via a structural element of the rotatable joint 330. It is further expressly contemplated that any or all of the rotation axes of 332 may be aligned (i.e. parallel in all dimensions) with the remaining rotation axes of the same rotatable joint 330 or of other rotatable joints 330 of the multi-axis boom 303.

In some embodiments, the rotation of a rotatable joint 330 about each rotation axis 332 is actuated independently by an actuator dedicated to the rotation axis 332. In some embodiments, the rotation of the rotatable joint 330 about multiple rotation axes 332 is actuated by a single actuator.

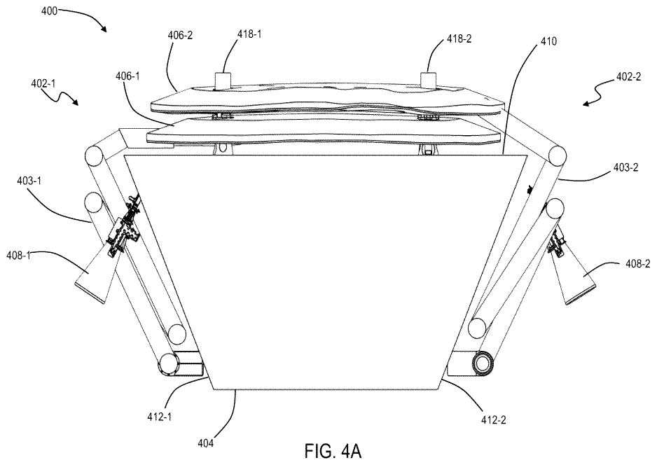

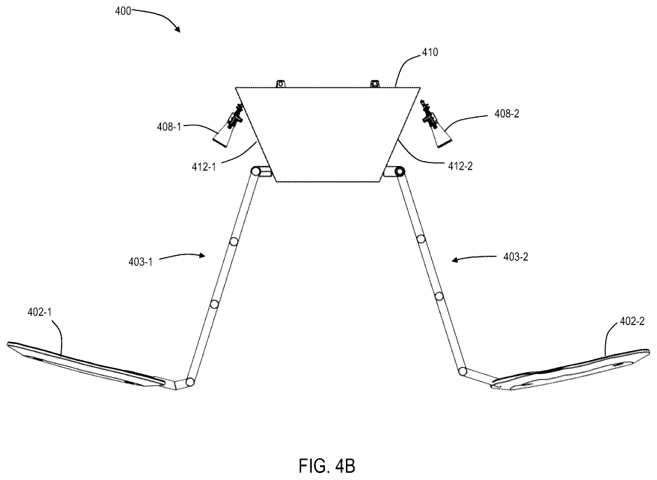

Referring now to FIGS. 4A and 4B shown therein is a system 400 for compact stowing of two antennas on a space vehicle, according to an embodiment.

The system 400 is shown in a stowed configuration in FIG. 4A and a (primary) deployed configuration in FIG. 4B.

System 400 includes first and second antennas 402-1 and 402-2 disposed on a platform 404 of the space vehicle. The platform 404 includes side platform surfaces 412-1 and 412-2 and nadir deck 410.

While in the embodiment of FIGS. 4A and 4B the multi-axis booms and antennas are on opposite sides of the platform, in other embodiments they may be on the same side or on adjacent sides.

The first antenna 402-1 includes feed device 408-1, and reflector 406-1, and reflector 406-1 is connected to multi-axis boom 403-1. The boom 403-1 is attached to the reflector 406-1 at one end and to the side panel 412-1 at a second end. The feed device 408-1 is mounted to side platform panel 412-1.

The second antenna 402-2 includes feed device 408-2, and reflector 406-2, and the reflector 406-2 is connected to multi-axis boom 403-2. The boom 403-2 is attached to the reflector 406-2 at one end and to the side panel 412-2 at a second end. The feed device 408-2 is mounted to side platform panel 412-2.

Both multi-axis booms 403-1 and 403-2 are four-axis booms comprising three boom segments connected end-to-end to the other boom segments by four rotatable joints. In some embodiments, the multi-axis booms may be five-axis booms which further include a rotatable joint which enables the reflector to be trimmed, as described herein. In other embodiments, the multi-axis boom may have as few as two axes or more than five axes.

In the stowed configuration of FIG. 4A, the reflectors 406-1, 406-2 are in a “dual stack” configuration in which the reflectors 406-1, 406-2 are stacked on top of one another, facing nadir deck 410. The reflectors 406-1, 406-2 are secured to the nadir deck 410 by HRMs 418-1, 418-2.

In the stowed configuration of FIG. 4A, the booms 402-1, 402-2 are in respective stowed configurations. The boom is configured, through operation of the component boom segments and rotatable joints, to fold in a manner that both positions the folded boom close to the respective sides 412-1, 412-2 and position the attached reflector 406-1, 406-2 close to the nadir deck 410 (by effectively stacking the reflectors) to minimize and/or optimize the volume that is occupied by antenna 402 components when stowed.

The boom segment 420-4 of the second multi-axis boom 403 is oriented and fixed to the second stowable equipment 406-2 at angles that, in a stowed configuration, disposes the second stowable equipment 406-2 closer to the nadir deck 410 (i.e. at a smaller offset 411) than the offset 411 of first stowable equipment 406-1.

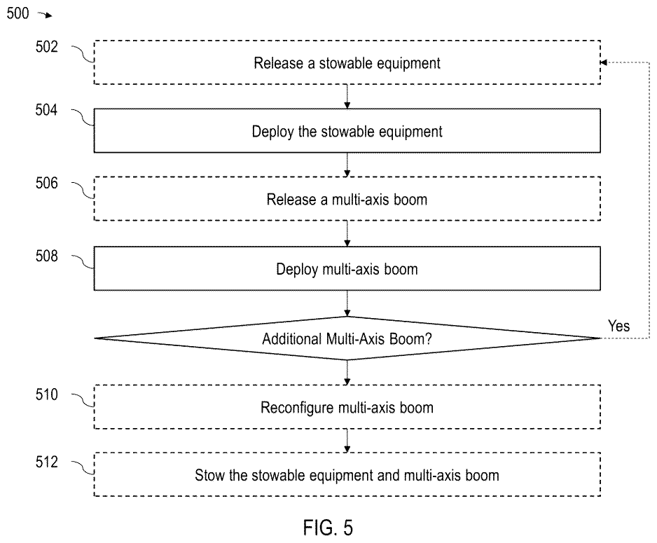

Referring now to FIG. 5, shown therein is a method 500 of deploying a stowable equipment via a multi-axis boom, (i.e., a deployment sequence 500) according to an embodiment. As above, the stowable equipment may be at least one antenna or at least one antenna component (e.g., reflector) and the stowable equipment may be on a space vehicle/spacecraft.

The multi-axis boom and stowable equipment may be the multi-axis boom 103, 203, 303, 403-1, and/or 403-2 and stowable equipments 106, 206, 406-1, and/or 406-2 of FIG. 1A through 4B.

Deploying the stowable equipment configures the stowable equipment in a deployed configuration, such as an antenna geometry.

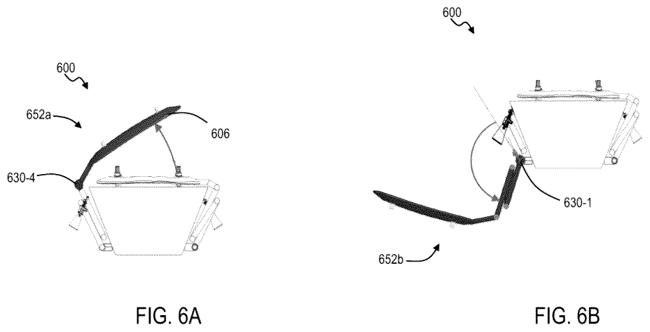

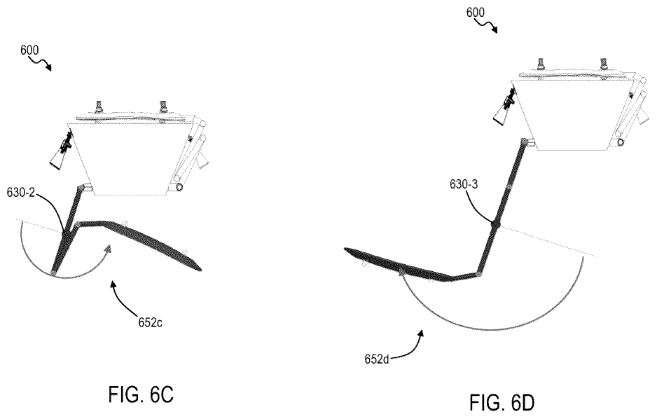

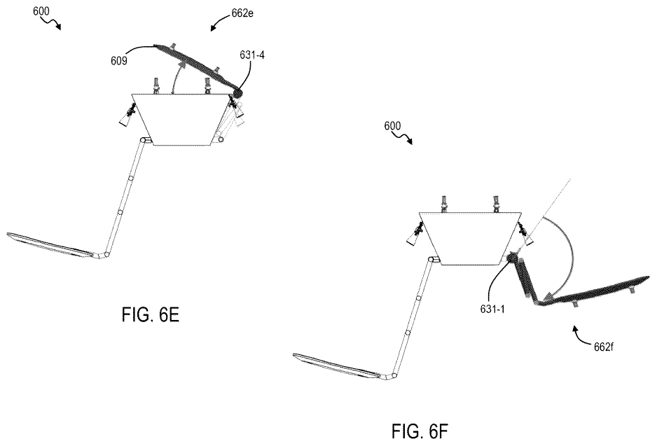

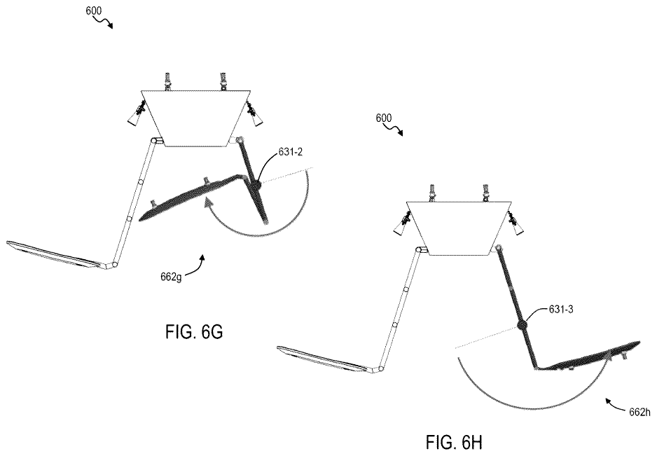

Referring to FIG. 6A to 6H shown therein are side view schematics of a system 600, for compact stowing on a space vehicle, in various configurations according to the deployment sequence 500, according to an embodiment. System 600 may be similar to system 100, system 200, or system 400.

Referring again to FIG. 5, at 502, the deployment sequence 500 may include releasing a first stowable equipment. Releasing the first stowable equipment includes firing stowable equipment HRMs releasably holding a first stowable equipment. It will be appreciated each stowable equipment HRM of those fired may be releasably holding more than one stowable equipment. Each releasable hold of each and every boom HRM may be configured to release the held component simultaneously or independently, such as in a sequence.

In other embodiments, the stowable equipment may not be held by an HRM, and therefore releasing the stowable equipment is not necessary (as shown by the dashed lines of box 502).

At 504, the deployment sequence 500 includes an initial deployment of the stowable equipment deployment. The initial deployment includes clearing the stowable equipment from a platform of the space vehicle such that the stowable equipment is sufficiently spaced from the platform to proceed with the deployment. Clearing the stowable equipment may include rotating a distal rotatable joint to orient a distal boom segment and the stowable equipment away from the side of the platform the stowable segment is stowed against.

Referring again to FIG. 6A, the stowable equipment 606 (not labelled in 6B-6H) is configured in an initial deployment 652a. In the initial deployment 652a, the rotatable joint 630-4 is configured at a rotation of approximately 30 degrees from the stowed configuration of a rotatable joint 630-4. The configuration can also be seen in FIG. 2A.

Referring again to FIG. 5, at 506, the deployment sequence 500 may include releasing a first multi-axis boom. Releasing the first multi-axis boom includes firing boom HRMs releasably holding a first multi-axis boom. It will be appreciated that each boom HRM of those fired may be releasably holding more than one multi-axis boom or multiple components of the first multi-axis boom. Each releasable hold of each and every boom HRM may be configured to release the held component simultaneously or independently, such as in a sequence.

In other embodiments, the multi-axis boom may not be held by an HRM, and therefore releasing the multi-axis boom is not necessary (as shown by the dashed lines of box 506).

At 508, the deployment sequence 500 includes deploying the first multi-axis boom. Deploying the first multi-axis boom includes rotating rotatable joints of the first multi-axis boom. The rotations of each and every rotatable joint may be any rotation that does not cause the multi-axis boom and stowable equipment to interfere with other objects including themselves or the platform. By determining and implementing various rotations, the multi-axis boom accommodates a range of deployed configurations. As such, the connected stowable equipment may be configured in a range of positions and orientations. This range of positions and orientations beneficially accommodates a range of missions, tasks and/or operations.

The rotations may be predetermined. For example, a deployment configuration may be tested terrestrially prior to launch. The rotations to achieve the boom segment orientations of the deployment configuration may be recorded at testing and reimplemented or implemented on the same or similar space vehicle once the space vehicle is in the field (i.e. in orbit and/or space).

The rotations may further be determined remotely. Remote determination of the parameters may be based on modeling such as physical or computer modeling. A multi access boom capable of being configured remotely based on modeling beneficially accommodates development and testing while the space vehicle is deployed or physically at other stages such as launch. The remote determination may further enable simpler and more controlled testing than onsite determination as modeling may occur in environment that is more controllable and easier to access and work in such as terrestrial or computerized environments.

Referring again to FIGS. 6B through 6D, the first stowable equipment 606 is configured in a deployed configuration 652d (i.e. deployed) as shown in FIG. 6D. Intermediate configurations 652b and 652c of the deployment corresponding to the rotations of rotatable joints 630-1 and 630-2, respectively, are shown in FIGS. 6B and 6C, respectively. In the configurations 652b through 652d, rotatable joint 630-1 is rotated approximately 135 degrees, rotatable joint 630-2 is rotated approximately 172 degrees, and rotatable joint 630-3 is rotated approximately −172 (i.e., 188) degrees from the stowed configuration of the rotatable joints 630-1, 630-2, and 630-3, respectively, as shown FIG. 6A (and FIG. 2A). The degrees of rotation shown serve only as examples and are not meant to limit the configurations. It will be appreciated that the rotations may be performed in sequences other than depicted and/or simultaneously.

Referring again to FIG. 5, 502 through 508 may be repeated for additional multi-axis booms. It will be appreciated that the configuration and specifically the rotations of the rotatable joints may differ across the multi-axis booms. These differences may be based, for example, on differences in the physical configuration and/or disposition of each multi-axis boom, external factors (i.e., environmental) affecting various multi-axis booms differently and/or different missions, tasks, or operations being performed.

Referring again to FIGS. 6E through 6H, the second stowable equipment 609 is deployed in a deployed configuration. In the configurations 662e through 662h, rotatable joint 631-4 is rotated approximately −30 (330) degrees, rotatable joint 631-1 is rotated approximately −135 (225) degrees, rotatable joint 631-2 is rotated approximately −172 (188) degrees, and rotatable joint 631-3 is rotated approximately 188 degrees from the stowed configuration of the rotatable joints 631-4, 631-1, 631-2, and 631-3, respectively, shown in FIG. 6A. As above, the degrees of rotation shown serve as examples and do not limit the configurations. It will be appreciated that that the rotations may be performed in sequences other than depicted and/or simultaneously.

Referring again to FIG. 5, at 510, the deployment sequence may include transitioning the multi-axis boom from a first deployed configuration to a second deployed configuration.

The mission, task, operation and/or performance of the stowable equipment may be changed/improved by transitioning the multi-axis boom from a first deployed configuration to a second deployed configuration.

As above, in an example, the stowable equipment is an antenna reflector transitioned from a first position and/or orientation to a second position and/or orientation to zoom, trim, steer, align, realign, or maintain (i.e. reposition to distribute environment based wearing) the corresponding antenna.

Zooming is used to change the focal length (e.g., shorten or lengthen), thus changing the beam diameter. When used in conjunction with phase, the zooming can beneficially reduce the effect of scan loss.

Trimming is used to improve radiofrequency (RF) performances by moving around the mission boresight to find a position where the gain is maximized. Maximizing the gain mitigates the effect of constant misalignment errors. For example, the stowable equipment may be positioned initially in a position based on testing performed on earth. The position that will achieve optimal performance on site (i.e. in space) may be slightly different. Trimming optimizes the on-site performance by positioning the stowable equipment accordingly.

By rotating the rotatable joints, this transition may be achieved without external physical modification of the space vehicle. For example, each rotatable joint may be rotated to position the antenna reflector closer to the platform (i.e., at a shorter focal length). Modifying the geometry of the antenna using the rotatable joints to shorten the focal length may beneficially zoom the antenna.

At 512, the deployment sequence from 502 through 510 may be reversed to configure the space vehicle in a stowed configuration (i.e. stowing the space vehicle). Specifically, the rotatable joints may be rotated back such that the orientation of the boom segments are returned to that of the stowed configuration. In some embodiments, the HRMs are single use and returning to the stowed configuration does not include holding the stowable equipment and/or multi-axis boom with HRMs, but rather the multi-axis boom holds the stowable equipment in place. In other embodiments, the multi-axis boom(s) and stowable equipment(s) may be resecured by the same (as initial hold) or different HRMs.

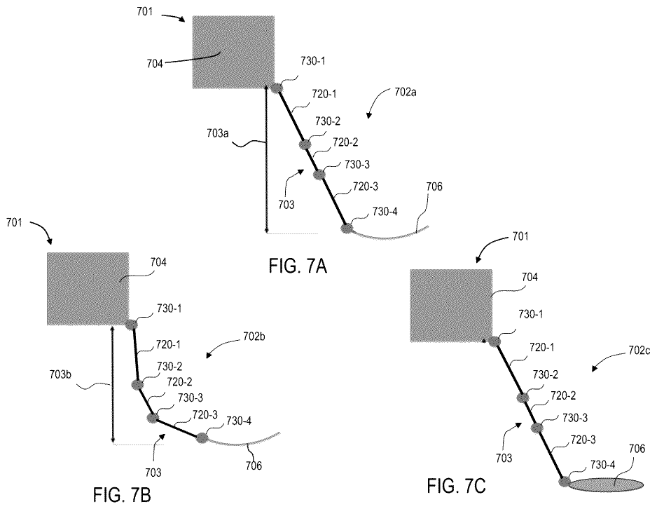

Referring now to FIGS. 7A through 7C, shown therein is a schematic representation of zooming and trimming of an antenna via a multi-axis boom, according to an embodiment.

FIG. 7A shows a space vehicle 701 with antenna 702 in an initial configuration 702a. FIG. 7B shows the antenna 702 in a zoomed configuration 700b. FIG. 7C shows the antenna 702 in a trimmed configuration 700c.

The antenna 702 may be a single offset antenna. The antenna 702 may be a Gregorian antenna with a sub-reflector mounted on the spacecraft or on another multi-axis deployable boom system.

The antenna 702 includes a multi-axis boom 703. The multi-axis boom 703 may be the boom 103 of FIG. 1A.

The multi-axis boom 703 is connected to a platform 704 of the space vehicle 701 at a first (proximal) end and to a reflector 706 of the antenna 702 at a second (distal end). The antenna 702 also includes a feed (not shown).

The multi-axis boom 703 is connected to the platform 704 and the reflector 706 via rotatable joints 730-1 and 730-4, respectively.

The multi-axis boom 703 includes a plurality of boom segments 720-1, 720-2, 720-3.

Boom segments 720-1 and 720-2 are connected via a rotatable joint 730-2.

Boom segments 720-2 and 720-3 are connected via a rotatable joint 730-3.

As the rotatable joints 730-2, 730-3 are not at an end of the boom 703, they may be referred to as intermediate rotatable joints.

The boom segments 720-1 to 720-3 are positioned at different orientations by action of the rotatable joints 730-1 to 730-4.

By rotating the rotatable joints 730-1 to 730-4, the orientation of the boom segments 720-1 to 720-3 can be changed so as to change the positioning of the reflector 706.

In the embodiment of FIGS. 7A-7C, rotatable joint 730-4 is configured to rotate about an axis that is not aligned with a rotation axis of the other rotatable joints 730.

Referring to FIG. 7B, the antenna 702 is in a “zoomed” configuration 702b relative to the initial configuration 702a.

Specifically, the multi-axis boom 703 is configured such that the reflector 706 is closer to the platform compared to the reflector 706 in the initial configuration 702a. As such, the antenna 702 in zoomed configuration 701b has a different focal length than the antenna 702 in the initial configuration 702a.

The reflector 706 in zoomed configuration 702b is brought closer to the platform 704 by rotating the rotatable joints 730 such that the relative angles between adjacent boom segments 720 change.

Referring to FIG. 7C, the antenna 702 is in a “trimmed” configuration 702c relative to the initial configuration 702a. The trimmed configuration 702c is trimmed in elevation.

The trimmed configuration 702c is achieved by rotating rotatable joint 730-4 about a rotation axis which is not aligned with at least one rotation axis of each of the remaining rotatable joints 730. For example, the rotation axis of rotatable joint 730-4 may be orthogonal to the rotation axes of rotatable joints 730-1, 730-2, and 730-3.

It will be appreciated that this rotatability of the rotatable joint 730-4 is not necessarily exclusive of the rotation in other rotation axes in those aligned with the remaining rotatable joints. That is, rotatable joint 730-4 may be rotatable in more than one axis.

It will further be appreciated that while the trimming shown is achieved via the distal rotatable joint 730-4, in some embodiments the trimming is achieved by any or all of the rotatable joints 730.

In some embodiments, the rotations to achieve the second deployed configuration 702b and third deployed configuration 702c from the first deployed configuration 702a may be combined to both zoom and trim the antenna 702.

Other combinations including rotations for alignment, maintenance, collision and wear avoidance, and the like are expressly contemplated.

The antenna 702 may include a feed (not shown) at the focal point.

It will be appreciated that the order and extent of the rotations may be different than at deployment. For example, stowing the space vehicle may be based on the deployed configuration just prior to stowing. Where the multi-axis boom was transitioned from a first deployed configuration to a second deployed configuration, the multi-axis boom and stowable equipment may be transitioned directly to the stowed configuration. It is not necessary to transition the space vehicle back to the first deployed configuration. Specifically, the rotations may be the reverse of rotations that would configure space multi-axis boom in second deployed configuration directly. Basing the rotations to achieve the reverse of the deployed configuration just prior to stowing may avoid causing damaging interference (i.e. crashes) between the multi-axis boom, the stowable and other objects including the platform.

In embodiments, such as where the space vehicle includes multiple stowable equipment, the stowing, deploying, and configurations thereof of a first stowable equipment (or other configurable equipment) may obstruct the stowing or deploying of a second stowable equipment. Therefore, the stowing or deployment sequence of the second stowable equipment, may include configuring the first stowable equipment or other stowable equipment, at least temporarily, to avoid interference between the second multi-axis boom and stowable equipment and other object objects such as the first multi-axis boom and stowable equipment.

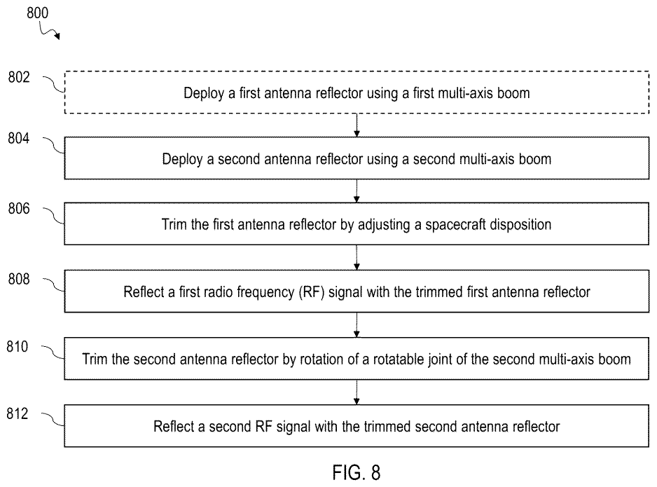

Referring to FIG. 8, shown therein is flow diagram of a method 800 of deploying a first and second antenna of a spacecraft, according to an embodiment. The first and second antennas are mounted on the same spacecraft platform or bus.

The payloads of FIG. 8 are antennas, but in other embodiments could be any other deployable payloads.

At 802, the method 800 may include deploying a first antenna reflector from a stowed configuration to a deployed configuration. The deployment may use a first multi-axis boom. In an embodiment, the first multi-axis boom is a four-axis boom, such as boom 203 of FIG. 2B.

At 804, the method 800 includes deploying a second antenna reflector from a stowed configuration to a deployed configuration using a second multi-axis boom. In an embodiment, the second multi-axis boom is five-axis boom, such as boom 303 of FIG. 3B.

It is expressly contemplated that the deployment at 802 of the first antenna reflector may be coordinated with the deployment at 804 of the second antenna reflector to avoid interference.

At 806, the method 800 includes trimming (or steering) the first antenna reflector in elevation. The trimming is performed by adjusting a disposition (position and/or orientation) of the spacecraft. Such adjustment is performed, for example, by a spacecraft position or attitude control system.

By adjusting the disposition of the spacecraft, the first antenna reflector is disposed in a trimmed orientation.

In some embodiments, the first antenna reflector may be further trimmed by rotating a rotatable joint of the first multi-axis boom, similar to the trimming of the second antenna reflector as further described at 810 below.

At 808, the method 800 includes reflecting a first RF signal with the trimmed first antenna reflector.

At 810, the method 800 includes trimming the second antenna reflector in elevation.

The trimming is performed by rotating an unaligned axis of the second multi-axis boom. Herein “unaligned” refers to rotation of a joint in a direction that is not parallel or “aligned” with the deployment of the boom sections of the multi-axis boom. The unaligned axis may be a rotation axis of any rotational joint of the multi-axis boom. That is, for example, trimming may be performed by a rotational joint closest to the antenna reflector, as shown in FIG. 7C, or may be performed by any rotational joint along the multi-axis boom which is capable of rotating for trimming.

Of note, while in some embodiments, as shown and described herein, the “aligned” joints are shown as having parallel axes of rotation, in other embodiments, at least some of the axes of rotation of the joints involved in deployment (or folding/unfolding of the boom) may be nonparallel. However, generally, the joints of the boom which are involved in deployment, or the “aligned” joints, function to move the antenna reflector, as a whole, away from the spacecraft or towards the spacecraft. This is in contrast to the “trimming” or “unaligned” joint(s) which has an rotation axis with an angle suitable for trimming and that functions to change the angle of the antenna reflector relative to a feed device of the antenna (which is disposed on the spacecraft).

As an example, the multi-axis boom may include four rotational joints each with a parallel rotation axis and the unaligned axis may be a secondary rotation axis of one of the four rotational joints which is misaligned from the remaining rotational joints.

In some embodiment, any or all joints which connect boom segments may be able to rotate along more than one axis.

It will be appreciated that the trimming of 810 may be to offset or compensate for unintended or incidental changes in the disposition of the second antenna reflector such as changes in the disposition of the first antenna reflector due to the trimming of the first antenna reflector at 806. Where the changes being offset or compensated for are projected, the trimming at 810 may include preemptive changes in the second antenna reflector disposition to preemptively offset or compensate for the projected changes. Examples of where preemptive compensation may occur include where there are scheduled movements of the spacecraft including where the trimming at 806 is performed after the trimming at 810.

At 812, the method 800 includes reflecting a second RF signal with the trimmed second antenna reflector.

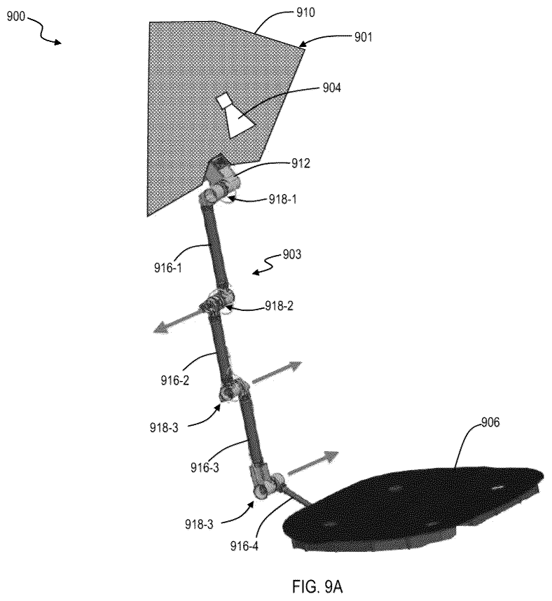

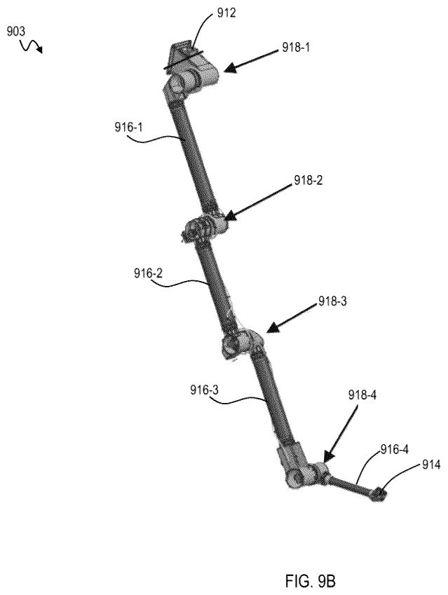

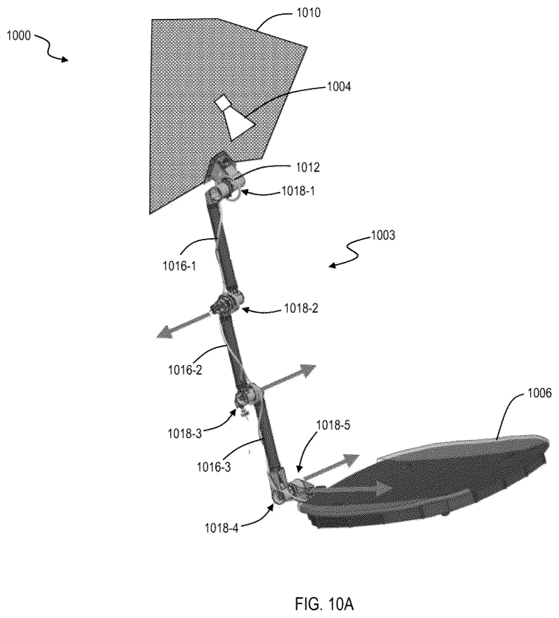

Referring now to FIGS. 9A and 9B, shown therein is a system 900 for compact stowing and deployment of an antenna on a space vehicle 901, according to an embodiment. FIG. 9A shows the antenna in a deployed configuration and FIG. 9B shows a boom 903 of the system 900 in isolation.

The system 900 includes a space vehicle 901. The antenna includes a feed device 904 mounted on platform of space vehicle 901, an antenna reflector 906 for reflecting RF waves to or from the feed device 904, and a boom 903.

The boom 903 is configured to fold to stow the reflector 906 on an earth or nadir deck 910 of the space vehicle 901 (the stowed configuration). In other embodiments, reflector 906 may be stowed on a side or panel of space vehicle 901 that is not a nadir deck.

The boom 903 is also configured to unfold from the stowed configuration to the deployed configuration shown in FIG. 9A.

The boom 903 includes a spacecraft interface component 912 for mechanically connecting the boom 903 to the space vehicle 901 at one end and a reflector interface component 914 (see FIG. 9B) for mechanically connecting the boom 903 to the reflector 906 at the other end.

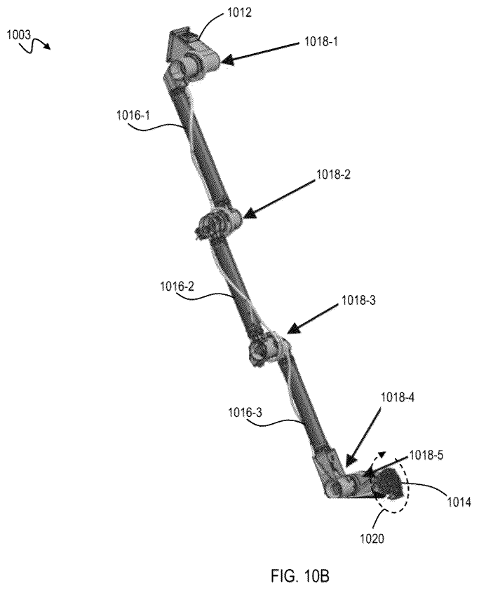

The boom 903 further includes four boom segments 916-1, 916-2, 916-3, and 916-4 and four joints 918-1, 918-2, 918-3, and 918-4. The boom 903 may be referred to as a four axis boom. The joints 918 each provide an axis of rotation (or rotational axis) of the boom 901. The rotational axis may be of a respective joint 918 may be driven by a motor (motorized axis). The joints 918 may be configured to allow only a limited angle between components connected by the joint 918. Such limitation of rotation may vary in different implementations and may depend on various considerations. The joints 918 may be considered rotatable joints. Each joint 918 may include a rotary actuator for effecting or driving rotation of the respective joint 918. In an embodiment, joints 918 may use respective stepper motors for deployment. In another embodiment, joints 918 may use respective spring hinges for deployment. Joints 918, and their respective axes of rotation, may be referred to as boom folding/unfolding joints or boom folding/unfolding axes given their function of folding and unfolding the boom 903 (and in contrast to, for example, a joint or axis for trimming, such as in FIG. 10A.

The joints 918-1, 918-2, 918-3, and 918-4 are configured to fold the boom 903 into a compact stowed configuration in which the reflector 906 is stowed on nadir deck 910. The joints 918-1, 918-2, 918-3, and 918-4 are configured to unfold the boom 903 from the stowed configuration to a deployed configuration where the reflector 906 is at a primary deployed position. The deployed position is a fixed deployed position, with the possibility to trim in Azimuth or to zoom (as described herein) through operation of one or more joints 918.

Joint 918-1 connects boom segment 916-1 to spacecraft interface component 912 and allows boom segment 916-1 to rotate relative to the spacecraft interface component 912 (which is fixed in position) within an allowable angle of rotation.

Joint 918-2 connects boom segment 916-2 to boom segment 916-1 and allows boom segment 916-2 to rotate relative to the boom segment 916-1 within an allowable angle of rotation.

Joint 918-3 connects boom segment 916-3 to boom segment 916-2 and allows boom segment 916-3 to rotate relative to the boom segment 916-2 within an allowable angle of rotation.

Joint 918-4 connects boom segment 916-4 to boom segment 916-3 and allows boom segment 916-4 to rotate relative to the boom segment 916-3 within an allowable angle of rotation.

In the embodiment shown in FIG. 9A-9B, the axes of rotation of joints 918-1 to 918-4 are parallel to one another. In other embodiments, the axes of rotation of joints 918-1 to 918-4 may be parallel or non-parallel. Note that parallel/non-parallel may also refer to a given rotation axis relative to the side on which the boom 903 is being deployed (as in FIG. 9A). In an embodiment, the joints 918-1 to 918-4 (for folding/unfolding the boom 903) may include multiple parallel axes of rotation and at least one non-parallel axis of rotation. In a particular embodiment, the at least one non-parallel axis of rotation includes a terminal folding/unfolding axis (i.e., at the terminal folding/unfolding joint, which is the joint closest to the reflector 906 that is used to fold/unfold the boom 903 (i.e., joint 918-4)).

Boom segment 916-4 is further fixedly connected to reflector interface component 914, attaching the boom 903 to the reflector 906.

It should be noted that, in the embodiment of FIGS. 9A-9B, the joints 918 are configured such that joints 918-1 and 918-2 both dispose the rotating boom segment on the same side of the joint 918, while joints 918-3 and 918-4 both dispose the rotating boom segment on the same, but opposite side of the joint 918 from joints 918-1, 918-2. In other embodiments, such positioning of rotating components relative to the joint may vary.

In operation, the boom 903 may be deployed from the stowed configuration as illustrated in FIGS. 6A-6D or FIGS. 6E-6H.

Once the boom 903 is deployed to the deployed configuration and the reflector 906 is at the primary deployed position as shown in FIG. 9A, the joints 918 may be used to change the distance of the reflector 906 from the space vehicle 901, thereby changing the focal length of the antenna. This may be referred to as a secondary reflector position (i.e., a position different from the primary deployed position). For example, the joints 918 may be actuated modify the angles between adjacent boom segments 916 to achieve the optimal positioning of the reflector 906 with respect to the space vehicle. An example of this is shown in FIGS. 7A-7B. Such a zooming operation may be carried out on orbit. Similarly, the joints 918 may be actuated to increase the angle between adjacent boom segments 916 to move the reflector 906 further away from the space vehicle 901.

Further, once the boom 903 is deployed to the deployed configuration and the reflector 906 is at a deployed position as shown in FIG. 9A, the joint 918-4 may be used to trim the antenna in azimuth.

Referring now to FIG. 10A, shown therein is a system 1000 for compact stowing and deployment of an antenna on a space vehicle 1001, according to an embodiment. FIG. 10A shows the antenna in a deployed configuration.

System 1000 is a variation of system 900 of FIG. 9A. Counterpart components performing the same or similar function in system 1000 as in system 900 are given the same last two digits (i.e., 9xx, 10xx). Certain counterpart components may not be described in reference to FIG. 10A.

System 1000 includes space vehicle 1001 with nadir deck 1010, antenna feed device 1004, reflector 1006, and boom 1003. As in system 900, the boom 1003 is configured to fold and unfold via joints 1018 to stow the reflector 1006 (on nadir deck 1010) and deploy the reflector to a primary deployed position, respectively.

In system 1000, boom 1003 includes one less boom segment and an additional joint 1018-5. The boom 1003 may be referred to as a five axis boom. Joint 1018-5 may be structurally and functionally similar to joints 918 of FIGS. 9A-9B, unless otherwise noted.

As in the system 900 of FIGS. 9A-9B, joints 1018-1 to 1018-4, which are used to fold/unfold the boom 1003, have axes of rotation that may be parallel or non-parallel relative to each other.

Joint 1018-4 connects joint 1018-5 to boom segment 1016-3 and allows joint 1018-5 to rotate relative to the boom segment 916-3 within an allowable angle of rotation.

Joint 1018-5 connects reflector interface component 1014 to joint 1018-4 and allows the reflector interface component 1014 (and thus reflector 1006 to which it is fixedly connected) to rotate relative to the joint 1018-4 within an allowable angle of rotation.

It should be noted that, in the embodiment of FIGS. 10A-10B, the joints 1018-1 to 1018-4 are configured such that joints 1018-1 and 1018-2 both dispose the rotating boom segment on the same side of the joint 1018, while joints 1018-3 and 1018-4 both dispose the rotating boom segment or joint on the same, but opposite side of the joint 1018 from joints 1018-1, 1018-2. In other embodiments, such positioning of rotating components relative to the joint may vary.

Joint 1018-4 may be used to trim the antenna along the axis of rotation of joint 1018-4, as well as to unfold the antenna. Trimming and unfolding by joint 1018-4 is the same movement, with trimming referring to finer movements intended to align the reflector properly with the feed 1004.

Joint 1018-5 has an axis of rotation that is nonparallel to the axis of rotation of joint 1018-4. Rotation that may be imparted by joint 1018-5 on reflector interface component 1014 is denoted by hashed line 1020.

The axis of rotation of joint 1018-5 may be configured at any angle relative to the axis of rotation of joint 1018-4 that is suitable for trimming (i.e., at an angle for trimming). In an embodiment, the angle is 90 degrees. In an embodiment, the angle is at or near 90 degrees. In an embodiment, the angle is within a range of 80 degrees to 90 degrees (e.g., 80, 85, etc.). Generally, the closer the angle is to 90 degrees, the better the trimming.

Joint 1018-5 may be used to trim the antenna (e.g., while on orbit). In this way, joint 1018-5 may be actuated to move the reflector 1006 from its primary deployed position as in FIG. 10A to a secondary deployed position (trimmed position), such as by rotating along 1020. An example of such trimming is shown in FIGS. 7A and 7C.

While in FIG. 10A, joint 1018-4 is described as a trimming joint (as well as a folding joint), in other embodiments any of the folding joints may be a trimming joint as long as the axis of rotation of the folding joint if suitable for trimming relative to the axis of rotation of the fifth trimming joint (e.g., joint 1018-5).

While FIGS. 9A-9B and 10A-10B describe four axis and five axis booms, respectively, and certain numbers of boom segments and rotational axes, it is understood that other embodiments may incorporate a similar configuration or design but use a different number of boom segments or rotational axes. For example, the configuration of joint 1018-4 and 1018-5 in system 1000 may be used at a terminal end of a boom (i.e., connected to the reflector) with a different number of boom segments or at a different location along the length of a boom (e.g., between boom segments).

While the above description provides examples of one or more apparatus, methods, or systems, it will be appreciated that other apparatus, methods, or systems may be within the scope of the claims as interpreted by one of skill in the art.

1. A method of stowing and deploying an antenna, the method comprising:
stowing an antenna reflector on a spacecraft platform with a multi-axis boom, the multi-axis boom foldable at multiple joints;
releasing a first set of hold and release mechanism (HRM) securing the antenna reflector to the spacecraft platform; and
deploying the antenna reflector to a deployed position by sequentially unfolding the boom at the joints to reflect radiofrequency (RF) waves to or from a feed device.

2. The method of claim 1, wherein the antenna reflector is stowed on a nadir deck of the spacecraft platform, and wherein the boom when folded positions the antenna reflector parallel or near parallel to the nadir deck.

3. The method of claim 1, wherein sequentially unfolding the boom at the joints includes unfolding the boom via at least three joints.

4. The method of claim 1, further comprising actuating at least one of the joints of the boom to move the antenna reflector closer to the spacecraft platform or further away from the spacecraft platform to change a focal length of the antenna.

5. The method of claim 1, wherein the boom includes a trimming joint for trimming the antenna by rotating the antenna reflector by the trimming joint.

6. The method of claim 5, wherein trimming joint trims the antenna in elevation by rotating the trimming joint.

7. The method of claim 6, wherein the method further comprises trimming the antenna in azimuth by at least one of the multiple joints, wherein the axis of rotation of the trimming joint and the axis of rotation of the at least one of the multiple joints are approximately orthogonal.

8. The method of claim 1, wherein the antenna is a first antenna and the antenna reflector is a first antenna reflector, the method further comprising performing, for a second antenna on the spacecraft platform:
stowing a second antenna reflector on the spacecraft platform with a second multi-axis boom, the second multi-axis boom foldable at multiple joints;
releasing a second set of hold and release mechanism (HRM) securing the second antenna reflector to the spacecraft platform; and
deploying the second antenna reflector to a deployed position by sequentially unfolding the second boom at the joints to reflect radiofrequency (RF) waves to or from a second feed device;
wherein the second antenna reflector and the first antenna reflector are stacked on one another when stowed.

9. The method of claim 8, wherein the first and second antenna reflectors are stowed on a nadir deck of the spacecraft platform.

10. The method of claim 9, wherein the first antenna and the second antenna deploy on opposite sides of the spacecraft platform.

11. A system for stowing and deploying an antenna on a spacecraft, the system comprising:
a feed device for transmitting and/or receiving radiofrequency (RF) waves;
an antenna reflector for reflecting the RF waves to or from the feed device;
a boom attached to the antenna reflector and to the spacecraft, the boom comprising a plurality of joints for folding the boom to stow the antenna reflector and sequentially unfolding the boom to deploy the antenna reflector to a deployed position.

12. The system of claim 11, wherein the boom comprises an additional joint for trimming the antenna, the additional joint having an axis of rotation that is nonparallel to the parallel axes of rotation for unfolding the boom.

13. The system of claim 12, wherein the additional joint is for trimming in elevation.

14. The system of claim 11, wherein the boom includes at least two boom segments connected in series and three joints, and wherein one of the three joints is either (i) coupled to a third boom segment that is fixedly attached to the antenna reflector, or (ii) coupled to a fourth joint that is coupled to the antenna reflector and that rotates along an axis of rotation nonparallel to the one of the three joints.

15. The system of claim 14, wherein rotation of the fourth joint trims the antenna in elevation.

16. The system of claim 11, wherein the antenna reflector is stowed on a nadir deck of the spacecraft platform, and wherein the boom when folded positions the antenna reflector parallel or near parallel to the nadir deck.

17. The system of claim 11, wherein sequentially unfolding the boom at the joints includes unfolding the boom via at least three joints.

18. The system of claim 11, wherein the boom adjusts a focal length of the antenna by actuating at least one of the joints to move the antenna reflector closer to the spacecraft platform or further away from the spacecraft platform.

19. The system of claim 11, wherein the antenna is a first antenna and the system further comprises a second antenna, the second antenna comprising:
a second feed device for transmitting and/or receiving a second set of radiofrequency (RF) waves;
a second antenna reflector for reflecting the second set of RF waves to or from the second feed device;
a second boom attached to the second antenna reflector and to the spacecraft, the second boom comprising a second plurality of joints for folding the second boom to stow the second antenna reflector on top of the antenna reflector of the first antenna and unfolding the boom to deploy the second antenna reflector to a second primary deployed position.

20. The system of claim 19, wherein the first and second antennas deploy on opposite sides of the spacecraft platform.
